(19) United States
(12) Patent Application Publication
(10) Pub. No.: US 2014/0067714 A1
(43) Pub. Date: Mar. 6, 2014

(54) METHODS AND APPARATUS FOR PERFORMING AN ANALYSIS OF SUSTAINABILITY OF A RETIREMENT INVESTMENT PORTFOLIO

(71) Applicants: Gregory Melton, Needham, MA (US); Glen Gibbons, Barrington, RI (US); Bruce Harrington, Plainville, MA (US)

(72) Inventors: Gregory Melton, Needham, MA (US); Glen Gibbons, Barrington, RI (US); Bruce Harrington, Plainville, MA (US)

(21) Appl. No.: 13/607,292

(22) Filed: Sep. 7, 2012

Related U.S. Application Data
(60) Provisional application No. 61/697,779, filed on Sep. 6, 2012.

(51) Int. Cl. G06Q 40/06

(52) U.S. Cl. CPC G06Q 40/06
USPC 705/36 R

(57) ABSTRACT

Described herein are methods and apparatus for performing an interactive, computer-implemented analysis of the sustainability of an investment portfolio to support a retirement income need for a client. In certain embodiments, the technology determines an optimum allocation of an investment portfolio in accordance with client goals, conveys a measure of the sustainability of the investment portfolio to provide sufficient income over the length of the client's retirement, allows adjustment of the portfolio by the client, determines a revised measure of sustainability, and provides information about the potential financial legacy that will be left to the client's heirs.

### RELATED APPLICATION

The present application claims priority to U.S. Provisional Application No. 61/697,779 entitled “Methods and Apparatus For Performing an Analysis of Sustainability of a Retirement Investment Portfolio” and filed Sep. 6, 2012, the contents of which are hereby incorporated by reference in their entirety.

### BACKGROUND

The financial services industry helps individuals diversify and build a financial portfolio that will accumulate a sufficient amount of funds at retirement and beyond using asset allocation. The accumulation of funds is contingent upon allocating financial and human resources across a diverse allocation of investments.

In the next 20 years more than 78 million people will transition into retirement or semi-retirement. As individuals approach retirement, they start to wonder how to ensure their accumulated wealth lasts for their entire life. Concerns include inflation, the length of life, and markets not performing as expected.

Income planning for these individuals is essential to manage the new risks that retirement brings. Existing technologies typically emphasize asset allocation which focuses on diversification and risk. Using these technologies, an investor's tolerance for risks is evaluated and used in presenting investment choices. However, asset allocation alone may not be the best method for ensuring a client's retirement income needs are satisfied throughout retirement.

Changing market conditions, for example, heightened volatility over broad sectors of the market or other non-classical market behaviors, can diminish the benefit provided by standard tools currently used to determine investment options for retirement. Furthermore, current retirement planning tools lack the ability to present investment options in a way that is both user-friendly and that conveys important information about both the risk involved that a given investment plan can adequately provide income over the entire period of retirement, as well as information about the financial legacy that will likely be left to the client's estate.

Moreover, in the event a client does not have adequate resources to sustain a desired retirement income level at a desired age of retirement, current computer-implemented retirement investment planning tools may fail to provide useful information. For example, an iterative calculation may fail to converge and no result is provided by the tool.

Additionally, current retirement investment planning tools may not facilitate the imposition of a requirement that there be minimum holdings maintained in a certain asset category (e.g., cash and cash equivalents), and they may not permit a user-friendly way of incorporating cash-value life insurance in the retirement income planning process.

Thus, there is a need for a user-friendly retirement income planning tool that adequately conveys a measure of the sustainability of an investment portfolio to provide sufficient income over the length of retirement, as well as information about a potential financial legacy that will be left to heirs. Additionally, there is a need for a tool that allows user-friendly adjustment of investment options to account for the relative importance of various investment goals to the client, as well as a client's risk tolerance. Moreover, there is a need for a user-friendly retirement investment planning tool that provides useful information in the event a client's desired retirement income or retirement age is not feasible. There is also a need for a tool that presents and accounts for cash-value life insurance options in the retirement plan in a user-friendly way, and that permits imposition of minimums in a given product silo.

### SUMMARY

Described herein are methods and apparatus for performing an interactive, computer-implemented analysis of the sustainability of an investment portfolio to support a retirement income need for a client. In certain embodiments, the technology determines an optimum allocation of an investment portfolio in accordance with client goals, conveys a measure of the sustainability of the investment portfolio to provide sufficient income over the length of the client's retirement, allows adjustment of the portfolio by the client, determines a revised measure of sustainability, and provides information about the potential financial legacy that will be left to the client's heirs. In certain embodiments, the measure of the sustainability of the investment portfolio over the length of retirement is determined from a probability that the stochastic present value of consumption is greater than the initial investable wealth.

An important feature of the disclosed technology, in certain embodiments, is a graphical user interface that allows a user to easily adjust an investment portfolio allocation proposed by the technology to account for the client's risk tolerance, liquidity needs, and investment goals, after which a measure of the sustainability of the investment portfolio to provide sufficient income over the length of the client's retirement, and a measure of the potential financial legacy, is recalculated.

Another important feature of the disclosed technology, in certain embodiments, is a graphical user interface that provides useful information in the event a client's desired retirement income or desired retirement age is not feasible given the client input. In certain embodiments, where a portfolio allocation that results in a minimum measure of sustainability or a minimum potential financial legacy cannot be determined, the technology determines a downwardly revised planned retirement income (and/or upwardly revised retirement age) that provides a minimum acceptable measure of sustainability over the length of retirement and/or a minimum potential financial legacy and offers the user the option to proceed with the revised income value (and/or revised retirement age).

Moreover, another feature of the disclosed technology, in certain embodiments, is a graphical user interface that presents incorporation of cash-value life insurance options in the retirement plan in a user-friendly way. Also, in certain embodiments, the technology permits imposition of minimums of a given product silo that must be held in the portfolio.

In one aspect, the invention is directed to a computer-implemented method for performing an analysis of sustainability of an investment portfolio to support a retirement income need for a client and displaying a result of the analysis, the method including the steps of: (a) providing, by a processor of a computing device, a graphical user interface configured to accept client-specific input; (b) determining, by the processor, a retirement income sustainability score corresponding to the client-specific input (e.g., RISS based on the current total investment portfolio as presently allocated or RISS based on allocation of projected total investment portfolio at time of retirement), wherein the retirement income sustainability score is a measure of sustainability of the investment portfolio to support the retirement income need for the client; (c) displaying, by the processor, the retirement income sustainability score corresponding to the client-specific input via the graphical user interface; (d) determining, by the processor, a first product allocation associated with the client-specific input (e.g., where the first product allocation is a reallocation of a current total investment portfolio selected to maximize retirement income sustainability score, or, e.g. where reallocation will take place at a later time, i.e., at the time of retirement, the first product allocation is a reallocation of a total investment portfolio at the time of retirement, said portfolio at the time of retirement predicted from the client-specific input); (e) displaying, by the processor, the first product allocation determined in step (d) (e.g., and also displaying the RISS corresponding to the first product allocation); (f) providing, by the processor, one or more graphical user interface widgets that allow adjustment of the first product allocation to a second product allocation; (g) determining, by the processor, an updated retirement income sustainability score corresponding to the second product allocation following step (f); and (h) displaying the updated retirement income sustainability score determined in step (g).

In certain embodiments, the client-specific input includes one or more members selected from the group consisting of client age (or birth date/birth year), desired number of years to retirement (or desired retirement age), current income, amount of desired retirement income (e.g., with cost-of-living adjustment), estimated amount of one or more sources of guaranteed income (e.g., pension, social security, immediate annuity, variable annuity with lifetime income guarantee), ‘start at’ age for each of the one or more sources of guaranteed income, amount of current total investment portfolio (e.g., broken down into percentage of cash, fixed income, and equity), and amount of planned expenses and/or deposits (e.g., amount, ‘at age’, and duration). In certain embodiments, the client-specific input includes at least a desired retirement income, a number of years to retirement, a current income, and a current total investment portfolio. In certain embodiments, the client is an individual. In certain embodiments, the client is a couple. For example, in certain embodiments, step (b) includes determining a joint retirement income sustainability score for the couple, and wherein step (f) includes providing, by the processor, the one or more graphical user interface widgets that allow adjustment of the first product allocation to the second product allocation for the couple, jointly. In certain embodiments, step (b) includes determining a retirement income sustainability score for each individual in the couple, and wherein step (f) includes providing, by the processor, the one or more graphical user interface widgets that allow adjustment of the first product allocation to the second product allocation for each individual in the couple.

In certain embodiments, the method further includes determining, by the processor, a potential financial legacy according to the client-specific input and displaying the potential financial legacy via the graphical user interface, along with the retirement income sustainability score, wherein the potential financial legacy is a probability-based value indicative of the size of a possible legacy (e.g., an estimated sum of the remaining value of the investment portfolio each year, multiplied by a probability of death that year, on a present value basis). In certain embodiments, step (c) includes displaying the retirement income sustainability score corresponding to the client-specific input in step (a) along with a graphical indication of asset allocation breakdown. For example, the graphical indication of asset allocation breakdown may include a chart indicating proportion of assets in cash, in fixed income, and in equity.

In certain embodiments, the first product allocation determined in step (d) is a reallocation of a current total investment portfolio corresponding to the client-specific input, said reallocation selected to maximize retirement income sustainability score, and wherein step (e) includes displaying the first product allocation and the maximized retirement income sustainability score corresponding to the first product allocation. For example, the first product allocation may be determined and displayed as an allocation among a plurality of asset categories. For example, the first product allocation may be determined and displayed as an allocation among at least two of the following three categories: investments (e.g., stocks, bonds, mutual funds, cash equivalents, and the like), variable annuities (e.g., variable annuities with lifetime income guarantees), and immediate annuities (e.g., single premium immediate annuities). In certain embodiments, the allocation in the category of investments is further determined and displayed as a sub-allocation in the subcategories of cash, fixed income, and equity. In certain embodiments, the allocation in the category of variable annuities is further determined and displayed as a sub-allocation in the subcategories of fixed income and equity.

In certain embodiments, the one or more graphical user interface widgets in step (f) allow independent adjustment of an allocation in each of the plurality of asset categories, thereby allowing adjustment by the user from the first product allocation to the second product allocation. In certain embodiments, the one or more graphical user interface widgets in step (f) includes a plurality of sliders, the position of each slider corresponding to an amount (e.g., a relative or absolute amount) of one of the plurality of asset categories. In certain embodiments, the one or more graphical user interface widgets in step (f) includes one or more of any number of the following: a window (e.g., collapsible panel, accordion, modal window, dialog box, palette window, inspector window, utility window, or frame), a text box, a button, a hyperlink, a drop-down list, a list box, a combo box, a check box, a radio button, a cycle button, a datagrid, a spinner, a menu (e.g., context menu, pie menu, ribbon), a menu bar, a toolbar, an icon, a tree view, a grid view, a link, a tab, and/or a scroll bar.

In certain embodiments, the method further includes the step of providing, by the processor, a further plurality of graphical user interface widgets that allow adjustment of a sub-allocation among a plurality of subcategories for one or more of the plurality of asset categories from a first sub-allocation to a second sub-allocation, wherein the updated retirement income sustainability score corresponds to the second allocation and the second sub-allocation. For example, the further plurality of graphical user interface widgets that allow adjustment of the sub-allocation may include one or more of any number of the following: a window (e.g., collapsible panel, accordion, modal window, dialog box, palette window, inspector window, utility window, or frame), a text box, a button, a hyperlink, a drop-down list, a list box, a combo box, a check box, a radio button, a cycle button, a datagrid, a spinner, a menu (e.g., context menu, pie menu, ribbon), a menu bar, a toolbar, an icon, a tree view, a grid view, a link, a tab, and/or a scroll bar.

In another aspect, the invention is directed to a computer-implemented method for performing an analysis of sustainability of an investment portfolio to support a retirement income need for a client and displaying a result of the analysis, the method including the steps of: (a) providing, by a processor of a computing device, a first graphical user interface configured to accept client-specific input; (b) determining, by the processor, a retirement income sustainability score corresponding to the client-specific input, wherein the retirement income sustainability score is a measure of sustainability of the investment portfolio to support the retirement income need for the client; (c) displaying, by the processor, the retirement income sustainability score corresponding to the client-specific input via the graphical user interface; (d) determining, by the processor, a first product allocation associated with the client-specific input; (e) displaying, by the processor, the first product allocation determined in step (d); (f) following step (e), displaying, by the processor, the first or a subsequent graphical user interface (e.g., the previous window or a new window) configured to accept client-specific input including: a desired face amount of life insurance and/or an amount of a life insurance premium; (g) determining, by the processor, a potential financial legacy without life insurance and a potential financial legacy with life insurance according to the client-specific input accepted in step (f), wherein the potential financial legacy is a probability-based value indicative of the size of a possible legacy (e.g., an estimated sum of the remaining value of the investment portfolio each year, multiplied by a probability of death that year, on a present value basis); (h) determining, by the processor, a retirement income sustainability score without life insurance and a retirement income sustainability score with life insurance according to the client-specific input accepted in step (f); and (i) displaying the potential financial legacy with life insurance, the potential financial legacy without life insurance, the retirement income sustainability score with life insurance, and the retirement income sustainability score without life insurance.

In certain embodiments, the client-specific input in step (f) further includes an indication of type of life insurance (e.g., whole, single life, or survivorship) and/or an indication of whether the client is a smoker. In certain embodiments, the method further includes the step of determining and displaying, by the processor, a life insurance premium corresponding to a desired face amount of life insurance where the client-specific input includes the desired face amount of life insurance. In certain embodiments, the method further includes the step of determining and displaying, by the processor, a face amount of life insurance corresponding to a life insurance premium where the client-specific input includes the life insurance premium. In certain embodiments, the first product allocation determined in step (d) is a reallocation of a current total investment portfolio corresponding to the client-specific input, said reallocation selected to maximize retirement income sustainability score (e.g., subject to one or more preconditions), wherein the method further includes the step of determining, by the processor, whether the maximized retirement income sustainability score (without life insurance) meets a predetermined criterion (e.g., is >=a predetermined minimum value or falls within a predetermined range), and proceeding to step (f) only if the criterion is met.

In certain embodiments, the client-specific input in step (f) further includes a selection by the client of a cash-value life insurance policy, and the method includes determining, by the processor, both the potential financial legacy with life insurance and the retirement income sustainability score with life insurance taking into account the cash value of the cash-value life insurance policy (e.g., wherein the cash value changes over time). In certain embodiments, the client-specific input in step (a) includes at least a desired retirement income, a number of years to retirement, a current income, and a current total investment portfolio.

In another aspect, the invention is directed to a computer-implemented method for performing an analysis of sustainability of an investment portfolio to support a retirement income need for a client and displaying a result of the analysis, the method including the steps of: (a) providing, by a processor of a computing device, a first graphical user interface configured to accept client-specific input, wherein the client-specific input includes at least a desired retirement income, a number of years to retirement, a current income, and a current total investment portfolio; (b) determining an amount of potential financial legacy (PFL) corresponding to the client-specific input, (e.g., where PFL is based on a re-allocation of the client's current total investment portfolio, or where PFL is based on a re-allocation of the client's a predicted portfolio at a later time, i.e., at time of retirement, said re-allocation chosen to maximize RISS and/or PFL, e.g., subject to constraints), wherein the potential financial legacy is a probability-based value indicative of the size of a possible legacy (e.g., an estimated sum of the remaining value of the investment portfolio each year, multiplied by a probability of death that year, on a present value basis), and/or determining, by the processor, a retirement income sustainability score (RISS) corresponding to the client-specific input (e.g., a maximized RISS with reallocated current investment portfolio or future predicted investment portfolio corresponding to the client-specific input), wherein the retirement income sustainability score is a measure of sustainability of the investment portfolio to support the retirement income need for the client, wherein the processor is configured, in the event the PFL is below a predetermined PFL threshold (e.g., zero) and/or the RISS is below a predetermined RISS threshold, to determine and display one or more of (i) a downwardly revised amount of desired retirement income, (ii) an upwardly revised number of years to retirement, and/or (iii) an upwardly revised level of assets at retirement that provides a PFL at or above the predetermined PFL threshold and/or that provides an RISS at or above the predetermined RISS threshold; (c) displaying, by the processor, an option for a user to select proceeding to step (d) with the downwardly revised amount of desired retirement income and/or displaying, by the processor, an option to select proceeding with the upwardly revised number of years to retirement; (d) determining, by the processor, a first product allocation associated with the client-specific input, including one or more of (i) the downwardly revised amount of desired retirement income, (ii) the upwardly revised number of years to retirement, and/or (iii) the upwardly revised level of assets at retirement, wherein the first product allocation is a reallocation of the current total investment portfolio that maximizes a computed retirement income sustainability score (RISS); and (e) displaying, by the processor, the RISS and displaying, by the processor, the first product allocation determined in step (d).

In certain embodiments, the method further includes: (f) providing, by the processor, one or more graphical user interface widgets that allow adjustment of the first product allocation to a second product allocation; (g) determining, by the processor, an updated retirement income sustainability score corresponding to the second product allocation following step (f); and (h) displaying the updated retirement income sustainability score determined in step (g). In certain embodiments, the client-specific input in step (a) includes at least a desired retirement income, a number of years to retirement, a current income, and a current total investment portfolio. In certain embodiments, the retirement income sustainability score (RISS) corresponding to the client-specific input is a maximized RISS with a reallocated current investment portfolio corresponding to the client-specific input. In certain embodiments, step (c) further includes displaying, by the processor, an option for the user to revise one or more of the following: the current total investment portfolio, the desired retirement income, and/or the number of years to retirement.

In another aspect, the invention is directed to a computer-implemented method for performing an analysis of sustainability of an investment portfolio to support a retirement income need for a client and displaying a result of the analysis, the method including the steps of: (a) providing, by a processor of a computing device, a graphical user interface configured to accept client-specific input; (b) determining, by the processor, a retirement income sustainability score corresponding to the client-specific input, wherein the retirement income sustainability score is a measure of sustainability of the investment portfolio to support the retirement income need for the client; (c) displaying, by the processor, the retirement income sustainability score corresponding to the client-specific input via the graphical user interface; (d) determining, by the processor, a first product allocation associated with the client-specific input, wherein the first product allocation is a reallocation of the client's current total investment portfolio that maximizes a computed retirement income sustainability score subject to a restriction that the first product allocation contain a predetermined minimum amount (e.g., absolute or relative) of a first product silo (e.g., a total of cash and cash equivalents); and (e) displaying, by the processor, the first product allocation determined in step (d).

In certain embodiments, the method further includes the steps of: (f) providing, by the processor, one or more graphical user interface widgets (e.g., slider bars) that allow adjustment of the first product allocation to a second product allocation, wherein the second product allocation is restricted to provide at least the predetermined minimum amount of the first product silo; (g) determining, by the processor, an updated retirement income sustainability score corresponding to the second product allocation following step (f); and (h) displaying the updated retirement income sustainability score determined in step (g). In certain embodiments, the client-specific input in step (a) includes at least a desired retirement income, a number of years to retirement, a current income, and a current total investment portfolio. In certain embodiments, the predetermined minimum amount of the first product silo is an absolute or relative minimum total of cash and cash equivalents in the first product allocation.

In another aspect, the invention is directed to a computer-implemented method for performing an analysis of sustainability of an investment portfolio to support a retirement income need for a client and displaying a result of the analysis, the method including the steps of: (a) providing, by a processor of a computing device, a first graphical user interface configured to accept client-specific input, wherein the client-specific input includes at least a desired retirement income, a number of years to retirement, a current income, and a current total investment portfolio; (b) determining, by the processor, a first product allocation associated with the client-specific input, wherein the first product allocation is a reallocation of the current total investment portfolio that yields a maximum potential financial legacy (PFL) while maintaining a pre-determined or user-selected minimum retirement income sustainability score (RISS), wherein the potential financial legacy is a probability-based value indicative of the size of a possible legacy (e.g., an estimated sum of the remaining value of the investment portfolio each year, multiplied by a probability of death that year, on a present value basis) and wherein the retirement income sustainability score is a measure of sustainability of the investment portfolio to support the retirement income need for the client; and (c) displaying, by the processor, the RISS, the PFL, and the first product allocation.

In certain embodiments, the first product allocation is determined and displayed as an allocation among a plurality of asset categories. In certain embodiments, the first product allocation is determined and displayed as an allocation among at least two of the following three categories: investments (e.g., stocks, bonds, mutual funds, cash equivalents, and the like), variable annuities (e.g., variable annuities with lifetime income guarantees), and immediate annuities (e.g., single premium immediate annuities). In certain embodiments, the allocation in the category of investments is further determined and displayed as a sub-allocation in the subcategories of cash, fixed income, and equity. In certain embodiments, the allocation in the category of variable annuities is further determined and displayed as a sub-allocation in the subcategories of fixed income and equity.

In certain embodiments, the method further includes the steps of: (d) providing, by the processor, one or more graphical user interface widgets that allow adjustment of the first product allocation to a second product allocation; (e) determining, by the processor, an updated potential financial legacy corresponding to the second product allocation following step (d); and (f) displaying the updated potential financial legacy determined in step (e). In certain embodiments, the one or more graphical user interface widgets in step (d) allow independent adjustment of an allocation in each of the plurality of asset categories, thereby allowing adjustment by the user from the first product allocation to the second product allocation. In certain embodiments, the one or more graphical user interface widgets includes a plurality of sliders, the position of each slider corresponding to an amount (e.g., a relative or absolute amount) of one of the plurality of asset categories.

In another aspect, the invention is directed to a computer-implemented method for performing an analysis of sustainability of an investment portfolio to support a retirement income need for a client and displaying a result of the analysis, the method including the steps of: (a) providing, by a processor of a computing device, a first graphical user interface configured to accept client-specific input, wherein the client-specific input includes at least a desired retirement income, a number of years to retirement, a current income, and a current total investment portfolio; (b) determining, by the processor, a first product allocation associated with the client-specific input, wherein the first product allocation is a reallocation of the current total investment portfolio that yields a maximum retirement income sustainability score (RISS) while maintaining a pre-determined or user-selected minimum potential financial legacy (PFL), wherein the retirement income sustainability score is a measure of sustainability of the investment portfolio to support the retirement income need for the client and wherein the potential financial legacy is a probability-based value indicative of the size of a possible legacy (e.g., an estimated sum of the remaining value of the investment portfolio each year, multiplied by a probability of death that year, on a present value basis); and (c) displaying, by the processor, the RISS, the PFL, and the first product allocation.

In certain embodiments, the first product allocation is determined and displayed as an allocation among a plurality of asset categories. In certain embodiments, the first product allocation is determined and displayed as an allocation among at least two of the following three categories: investments (e.g., stocks, bonds, mutual funds, cash equivalents, and the like), variable annuities (e.g., variable annuities with lifetime income guarantees), and immediate annuities (e.g., single premium immediate annuities). In certain embodiments, the allocation in the category of investments is further determined and displayed as a sub-allocation in the subcategories of cash, fixed income, and equity. In certain embodiments, the allocation in the category of variable annuities is further determined and displayed as a sub-allocation in the subcategories of fixed income and equity.

In certain embodiments, the method further includes: (d) providing, by the processor, one or more graphical user interface widgets that allow adjustment of the first product allocation to a second product allocation; (e) determining, by the processor, an updated retirement income sustainability score corresponding to the second product allocation following step (d); and (f) displaying the updated retirement income sustainability score determined in step (e). In certain embodiments, the one or more graphical user interface widgets in step (d) allow independent adjustment of an allocation in each of the plurality of asset categories, thereby allowing adjustment by the user from the first product allocation to the second product allocation. In certain embodiments, the one or more graphical user interface widgets includes a plurality of sliders, the position of each slider corresponding to an amount (e.g., a relative or absolute amount) of one of the plurality of asset categories.

In another aspect, the invention is directed to a computer-implemented method for performing an analysis of sustainability of an investment portfolio to support a retirement income need for a client and displaying a result of the analysis, the method including the steps of: (a) providing, by a processor of a computing device, a first graphical user interface configured to accept client-specific input, wherein the client-specific input includes at least a desired retirement income, a number of years to retirement, a current income, and a current total investment portfolio; (b) determining, by the processor, a first product allocation associated with the client-specific input, wherein the first product allocation is a reallocation of the current total investment portfolio that yields a maximum retirement income sustainability score (RISS), wherein the retirement income sustainability score is a measure of sustainability of the investment portfolio to support the retirement income need for the client; and (c) displaying, by the processor, the RISS and the first product allocation, wherein the determining, by the processor, of the first product allocation in step (b) is performed by assigning a measure of volatility (e.g. standard deviation) as a function of a pre-determined or client-selected assumed market growth rate.

In certain embodiments, the assigned measure of volatility is greater for a higher assumed market growth rate. In certain embodiments, the first product allocation is determined as a function of a fixed income and/or bond net rate of return, a bond volatility, a stock net rate of return, a stock volatility, and, optionally, a stock bond correlation coefficient.

In another aspect, the invention is directed to a non-transitory computer readable medium, wherein the computer readable medium stores instructions that, when executed by a processor, cause the processor to implement one or more of the methods described herein.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIGS. 1A through 1B are flow charts of methods for performing an analysis of the sustainability of an investment portfolio to support a retirement income need for a client, according to an illustrative embodiment of the invention.

FIG. 2 is a flow chart of example methods for determining and presenting a measure of the sustainability of an investment portfolio with and without life insurance, according to an illustrative embodiment of the invention.

FIG. 3 is a flow chart of example methods for determining and presenting a measure of the sustainability of an investment portfolio while accounting for a potential financial legacy, in accordance with an illustrative embodiment of the invention.

FIGS. 4A through 4B are flow charts of illustrative methods for determining and presenting a measure of the sustainability of an investment portfolio while accounting for a cash-value life insurance option, in accordance with an illustrative embodiment of the invention.

FIG. 5 is a diagram of an example graphical user interface for receiving client information, in accordance with an illustrative embodiment of the invention.

FIGS. 6A though 6B are screenshots of an example graphical user interface for displaying and modifying a current retirement income sustainability score, in accordance with an illustrative embodiment of the invention.

FIGS. 7A through 7B are screenshots of an example graphical user interface for adjusting an optimal product allocation, in accordance with an illustrative embodiment of the invention.

FIG. 8 is a screenshot of an example graphical user interface for presenting options to the user for proceeding with the analysis in the event a product allocation cannot be determined that provides the desired retirement income with a minimum allowable RISS and/or PFL, in accordance with an illustrative embodiment of the invention.

FIGS. 9A through 9D are screenshots of an example graphical user interface for incorporating life insurance into the determination of the sustainability of an investment portfolio, in accordance with an illustrative embodiment of the invention.

FIG. 10 is a screenshot of an example graphical user interface for reviewing results of a portfolio analysis, in accordance with an illustrative embodiment of the invention.

FIG. 11 is a screenshot of an example graphical user interface for creating a report of a portfolio analysis, in accordance with an illustrative embodiment of the invention.

FIG. 12 is a flowchart of an example method for determining a retirement income sustainability score and product allocation that yields a maximum potential financial legacy, in accordance with an illustrative embodiment of the invention.

FIG. 13 is a flowchart of an example method for determining a potential financial legacy and product allocation that yields a maximum retirement income sustainability score, in accordance with an illustrative embodiment of the invention.

FIG. 14 is a flowchart of an example method for determining a product allocation that yields a maximum retirement income sustainability score assuming a measure of volatility, in accordance with an illustrative embodiment of the invention.

FIG. 15 shows a block diagram of an exemplary cloud computing environment, in accordance with an illustrative embodiment of the invention.

FIG. 16 shows a block diagram of a computing device and a mobile device, in accordance with an illustrative embodiment of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

The term “widget,” as used herein, refers to one or more of any number of the following: a window (e.g., collapsible panel, accordion, modal window, dialog box, palette window, inspector window, utility window, or frame), a text box, a button, a hyperlink, a drop-down list, a list box, a combo box, a check box, a radio button, a cycle button, a data grid, a spinner, a menu (e.g., context menu, pie menu, ribbon), a menu bar, a toolbar, an icon, a tree view, a grid view, a link, a tab, a toggle switch, and/or a scroll bar.

The term “client,” as used herein, refers to at least one of the following: an individual, a couple, or a group of more than one person. As described in the implementations below, a processor may determine a value for a variable. Variables include, but are not limited to, a retirement income sustainability score, a potential financial legacy, and an optimal product allocation. In some implementations, the variable is determined for an individual if the client is an individual. In some implementations, if the client is a couple, the variable is determined for the couple, jointly. In other implementations, if the client is a couple, the variable is determined for each individual in the couple. In some implementations, if the client is a group of more than one individual, the variable is determined for the group, jointly. In other implementations, if the client is a group of more than one individual, the variable is determined for each individual in the group.

In some implementations, when a graphical user interface widget is used to adjust a variable, the variable is adjusted for the couple or group, jointly. In other implementations, when a graphical user interface widget is used to adjust a variable, the variable is adjusted individually for each member of the group or couple.

The term “potential financial legacy” (PFL), as used herein, refers to an estimate indicative of the approximate size of a possible legacy (e.g. assets including cash, equity, annuities, and investments) left by a decedent.

The term “retirement income sustainability score” (RISS), as used herein, is a measure of sustainability of the investment portfolio to support the retirement income need for the client. The processor utilizes a combination of factors to determine a retirement income sustainability score including at least one of: client specific inputs, a set of fixed background assumptions or parameters including capital market assumptions (e.g., equity and bond growth rates, market yields) as well as demographic assumptions (mortality), product parameters (e.g., insurance fee, withdrawal rates), payout rates and various minimum/maximum program parameters (e.g., age, dollar amounts, years to retirement).

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The disclosed technology provides financial professionals with a tool to determine the optimal retirement income solution for their clients. A part of this program is the retirement income sustainability score (RISS) analyzer which provides a client with a probability-based numeric indicating the status of their current retirement income strategy and a recommended product allocation mix designed to maximize either sustainable income or legacy.

The disclosed technology combines investment and product choices when it presents an optimal product category allocation to a client. The disclosed technology allows users to ‘analyze’ a client's current financial position by presenting a measure of retirement income sustainability, also known as a retirement income sustainability score (RISS), and potential financial legacy (PFL), in present value terms. The disclosed technology also allows users to optimize a client's financial assets by identifying the asset and product category allocation mix which will generate the highest possible RISS and corresponding PFL for a given set of input parameters.

The product category allocation is presented to the client and allows adjustment on the basis of their requirements regarding income sustainability, legacy, liquidity, risk tolerance and is balanced against their liquid assets and their income gap. The product category allocation includes one or more product categories that guarantee lifetime income and one or more asset growth categories. The disclosed technology also provides access to a computer executing software which calculates the solution.

In certain embodiments, the disclosed technology considers three principal financial and insurance categories for the construction of a comprehensive product allocation strategy. The first is investments using a systematic withdrawal plan (SWP). A SWP is a method by which a portfolio of mutual funds or a managed account is periodically liquidated to generate income. The second is variable annuities with guaranteed living income benefit. This includes guaranteed minimum withdrawal benefits for life and/or guaranteed minimum income benefits. This category captures the benefit and value of the market-contingent life annuities. The third is single premium immediate annuities. This product category captures the benefit and value of longevity protection within a retirement strategy.

The disclosed technology assesses the sustainability of a portfolio to support retirement income needs for life. As the allocation increases to products providing a sustainable source of income, such as annuities, the individual reduces the risk of outliving the portion of his or her assets allocated to investments and relies more heavily on guaranteed sources of income, thus increasing their income sustainability.

Optimized asset allocations, RISS, and PFL can be calculated using a variety of mathematical techniques, for example, using the techniques described in the article, “Self-Annuitization and Ruin in Retirement,” by Moshe Arye Milevsky & Chris Robinson, North American Actuarial Journal, Volume 4, Number 4, page 112 (2000), which is hereby incorporated by reference it its entirety. For example, RISS may be calculated from a lifetime probability of ruin (PoR) and an eventual PoR, where lifetime PoR is the probability that net wealth will become zero prior to a stochastic date of death, and eventual PoR is the probability that net wealth will ever become zero for an infinitely lived individual. The PoR can be represented as the probability that the stochastic present value of consumption is greater than the initial investable wealth. The lifetime and eventual PoR's can be obtained from the stochastic present value at the initial wealth level. Similar methods employing algorithmic simulations can be conducted separately, or can be used to confirm results.

There may be other methods of determining optimized asset allocations, RISS and/or PFL as well, for example, using techniques described in “Self-Annuitization, Ruin Risk in Retirement and Asset Allocation: The Annuity Benchmark,” by Peter Albrecht and Raimond Maurer, Jun. 1, 2001, Sonderforschungsbereich 504, Universitat Mannheim & Sonderforschungsbereich 504, University of Mannheim in its series Sonderforschungsbereich 504 Publications with number 01-35, which is hereby incorporated by reference it its entirety.

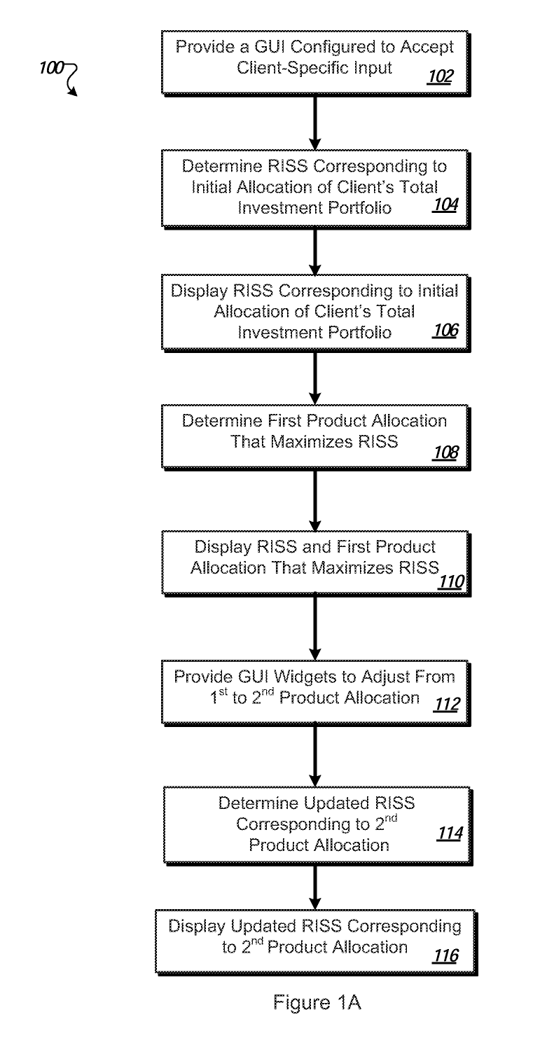

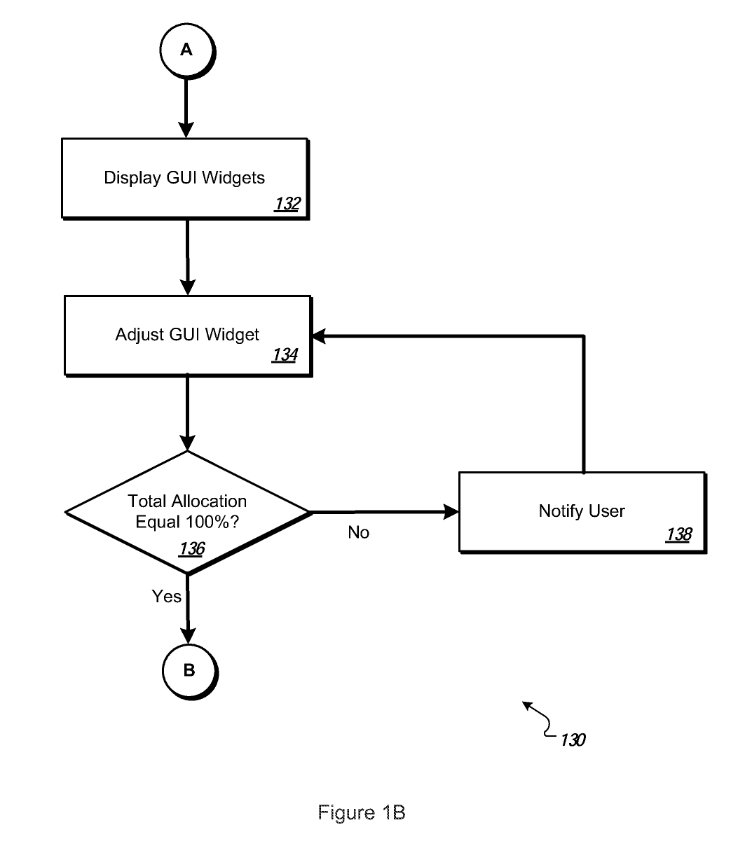

FIG. 1A illustrates, in accordance with some implementations, a method (100), performed by a processor of a computing device, for performing an analysis of sustainability of an investment portfolio to support a retirement income need for a client and displaying a result of the analysis.

In some implementations, method (100) begins by providing a graphical user interface (GUI) configured to receive client-specific input (102). The GUI is configured to receive client-specific input via widgets that can be adjusted by a user to input information specific to the client.

The client-specific input includes at least one of: client age, client birth date, client birth year, client gender, desired number of years to retirement, desired retirement age, inflation, current income, amount of desired retirement income, estimated amount of one or more sources of guaranteed income such as pension, social security, or other sources of guaranteed income, ‘“start at” age for each of the one or more sources of guaranteed income, and amount of planned expenses and/or deposits; client's initial total investment portfolio, also known as an initial product allocation, that includes cash, fixed income, and equity, and additional cash flows.

The amount of desired retirement income, also referred to as the retirement income need, may be determined using a variety of methods including: calculating a percentage of gross income, using a retirement expense calculator, or manually inputting data. In some implementations, the processor will automatically estimate the client's retirement income need (before taxes) to be a percentage of their current income, but this figure may be adjusted manually if necessary. In some implementations, a retirement expense calculator may be used to estimate the client's retirement expenses. This estimate is based on their current gross annual income and the Bureau of Labor Statistics Consumer Expenditure Survey (CES). The retirement expense calculator may be provided as an independent program or integrated program. The GUI (102) may provide a widget that a user can select to launch the retirement expense calculator. In some implementations, the retirement income need can be manually entered in the provided GUI (102).

In some implementations, the processor determines a RISS and/or PFL(104) corresponding to the client-specific input and initial product allocation and displays the RISS and/or PFL via the GUI (106). Additionally, the initial asset allocation breakdown (e.g. cash, fixed income, equity) may be displayed with the RISS and/or PFL using a plot, graph, chart, or alphanumeric characters. For example, the initial asset allocation breakdown may be displayed using a pie chart indicating the proportion of assets in cash, in fixed income, and in equity.

In some implementations, the processor determines a first product allocation associated with the client-specific input (108). The first product allocation may be a current total investment portfolio corresponding to the client-specific input or a reallocation of the current total investment portfolio that maximizes a computed RISS or a PFL. The first product allocation is an allocation amount in at least one of the following categories: investments (e.g. stocks, bonds, mutual funds, cash equivalents, and the like), variable annuities (e.g. variable annuities with lifetime income guaranteed), and immediate annuities (e.g. single premium immediate annuities). Additionally, the allocation in the category of investments may be further determined as a sub-allocation in the subcategories of cash, fixed income, and equity. The allocation in the category of variable annuities may be further determined as a sub-allocation in the subcategories of fixed income and equity. In some implementations, the maximization may be subject to a restriction that the first product allocation contain an absolute or relative predetermined minimum amount of a first product silo such as total of cash and cash equivalents.

In some implementations, the first product allocation, maximized RISS, and/or maximized PFL are displayed (110) via the GUI. The first product allocation may be displayed as an amount allocated to various asset categories. In some implementations, a measure of risk tolerance, a measure of importance of liquidity to the client, and/or an amount of PFL corresponding to the first product allocation are determined and displayed with the first product allocation.

In some implementations, one or more GUI widgets are provided (112) to adjust the first product allocation to a second product allocation. The one or more widgets may allow independent adjustment of an allocation in each of the plurality of asset categories, thereby allowing adjustment by the user from the first product allocation to the second product allocation. For example, the first product allocation may include 10% of an investment portfolio in cash, 50% in variable annuities, and 40% in immediate annuities. Using the widgets, a user can adjust the first product allocation to a second product allocation such as 20% of an investment portfolio in cash, 30% in variable annuities, and 50% in immediate annuities. The process of using the widgets to adjust the first product allocation to the second product allocation is described with reference to FIG. 1B.

In some implementations, the processor may provide a further plurality of GUI widgets that allow adjustment of a sub-allocation among a plurality of subcategories for one or more of the plurality of asset categories from a first sub-allocation to a second sub-allocation. In this implementation, the updated RISS and/or PFL correspond to the second allocation and/or the second sub-allocation.

In some implementations, the processor determines an updated RISS and/or PFL (114) corresponding to the second product allocation. In some implementations, the updated RISS and/or PFL may be determined automatically and/or in real-time when a user adjusts the widgets provided in step 112 to adjust the product allocation. In other implementations, the updated RISS and/or PFL may be determined when a user selects an option to update the RISS. Typically a user would select to update the RISS after using the widgets provided in step 112 to adjust the first product allocation to a second product allocation. For example, the user may select a “recalculate” button, or the like, to recalculate RISS after adjusting the product allocation. In some implementations, the updated RISS and/or PFL are displayed (116).

FIG. 1B illustrates a flow chart of an example method (130), performed by a processor of a computing device, for providing one or more GUI widgets. In some implementations, one or more GUI widgets are displayed (132). The one or more GUI widgets allow adjustment of the first product allocation to the second product allocation.

The GUI widgets can be used to adjust a product allocation (134) by changing the amount allocated to a specific investment category such as investments, variable annuities, or immediate annuities. For example, the one or more GUI widgets may comprise a plurality of sliders, each slider corresponding to an amount (e.g. relative or absolute) of one of the plurality of asset categories.

A total allocation is calculated to determine if the total allocation is 100% (136) prior to calculating the updated RISS and/or PFL (114) as explained in reference to FIG. 1A. If the total allocation is not 100%, the user is notified (138) when the processor attempts to determine an updated RISS and/or PFL (114, FIG. 1A). After receiving notification, the user can adjust one or more GUI widgets (134). This process continues until the user is satisfied with the product allocation and the total allocation equals 100%. At this point, the processor can determine an updated RISS and/or PFL (114, FIG. 1A) automatically or upon instruction from a user.

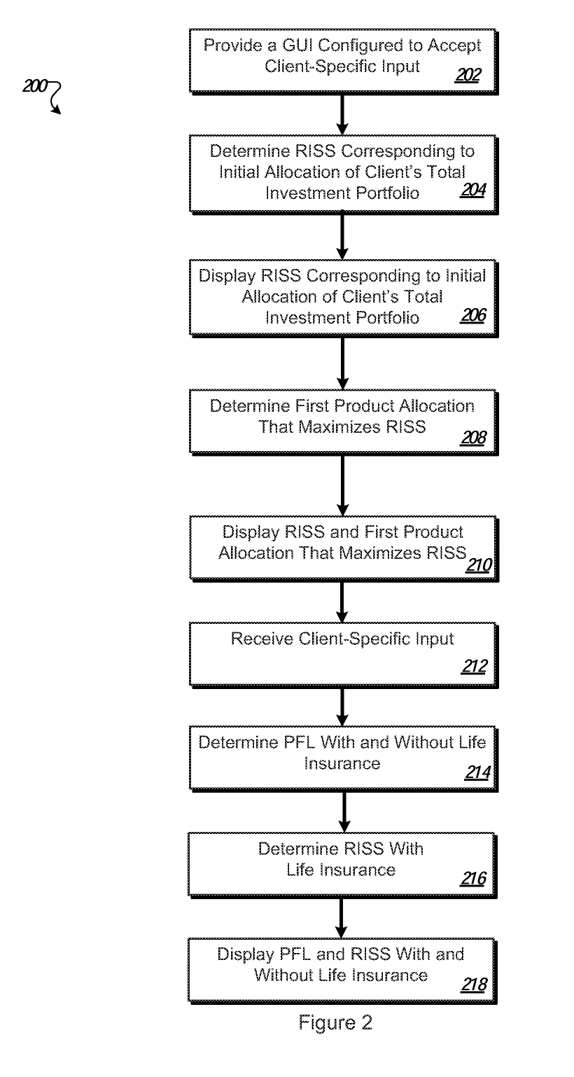

FIG. 2 illustrates, in accordance with some implementations, a method (200), performed by a processor of a computing device, for performing an analysis of sustainability of an investment portfolio to support a retirement income need for a client and displaying a result of the analysis.

In some implementations, method (200) begins by providing a first GUI (GUI) configured to accept a first client-specific input (202). The first GUI is configured to receive client-specific input via widgets.

The first client-specific input includes at least one of: client age, client birth date, client birth year, client gender, desired number of years to retirement, desired retirement age, inflation, current income, amount of desired retirement income, estimated amount of one or more sources of guaranteed income such as pension, social security, or other sources of guaranteed income, “start at” age for each of the one or more sources of guaranteed income, and amount of planned expenses and/or deposits; client's initial total investment portfolio, also known as an initial product allocation, that includes cash, fixed income, and equity, and additional cash flows.

In some implementations, a RISS and/or PFL are determined (204) corresponding to the first client-specific input and is displayed via the GUI (206). Additionally, the asset allocation breakdown (e.g. cash, fixed income, equity) may be displayed with the RISS and/or PFL using a plot, graph, chart, or alphanumeric characters. For example, the asset allocation breakdown may be displayed using a pie chart indicating the proportion of assets in cash, in fixed income, and in equity.

In some implementations, the processor determines a first product allocation associated with the first client-specific input (208). The first product allocation may be a current total investment portfolio corresponding to the client-specific input or a reallocation of the current total investment portfolio that maximizes a computed RISS and/or PFL. The first product allocation is an allocation amount in at least one of the following categories: investments (e.g. stocks, bonds, mutual funds, cash equivalents, and the like), variable annuities (e.g. variable annuities with lifetime income guaranteed), and immediate annuities (e.g. single premium immediate annuities). Additionally, the allocation in the category of investments may be further determined as a sub-allocation in the subcategories of cash, fixed income, and equity. The allocation in the category of variable annuities may be further determined as a sub-allocation in the subcategories of fixed income and equity. In some implementations, the maximization may be subject to a restriction that the first product allocation contain an absolute or relative predetermined minimum amount of a first product silo such as total of cash and cash equivalents.

In some implementations, the first product allocation and/or maximized RISS are displayed (210) via the GUI. The first product allocation may be displayed as an allocation amount a plurality of asset categories. In some implementations, a measure of risk tolerance, a measure of importance of liquidity to the client, and/or a legacy corresponding to the first product allocation are determined and displayed with the first product allocation. The user may choose to adjust the product allocation at her discretion, e.g., via widgets such as slider-bars, for example, to account for client risk tolerance, liquidity needs, and/or investment goals, after which a measure of the RISS and/or PFL may be recalculated. The user may continue to make allocation adjustments and initiate recalculation of RISS and/or PFL until satisfied.

In some implementations, the first or a subsequent GUI is configured (e.g. the previous window or a new window) to accept a second client-specific input (212). The second client-specific input may consist of, but is not limited to, a desired face amount of life insurance and/or an amount of a life insurance premium. Additionally, the second client-specific input may include an indication of the type of life insurance (e.g. whole, single life, or survivorship) and/or an indication of whether the client is a smoker. The second client-specific input may be used in a proxy calculation for either the premium or the face amount of a life insurance policy. This proxy calculation is based on the age, coverage type, smoker status, and either life insurance death benefit amount or an annual premium amount input and a standard underwriting status. The first or the subsequent user interface may display a face amount of life insurance corresponding to a life insurance premium where the second client-specific input includes the life insurance premium. Additionally, the life insurance options may be restricted where the determined RISS and/or PFL are at least a pre-determined minimum value.

In some implementations, a PFL without life insurance and a PFL with life insurance are determined (214) according to the first and/or second client-specific input. Additionally, a RISS without life insurance and a RISS with life insurance are determined (216) according to the first and/or second client-specific input. The processor may either calculate the RISS without life insurance or fetch the value if it was previously calculated and stored. After the PFL and/or RISS are determined with and without life insurance, the value are displayed (218).

In some implementations, the second client-specific input may include a cash-value life insurance policy where the cash value of the policy changes over time. In this case, the processor may determine both the PFL with life insurance and the RISS with life insurance taking into account the cash value of the cash-value life insurance policy.

In some implementations, the processor determines whether the maximized RISS without life insurance meets a predetermined criterion. For example, the processor could determine whether the RISS is greater than or equal to a pre-determined minimum value or falls within a predetermined range. After making the comparison, the processor proceeds to step 212 only if the criterion is met.

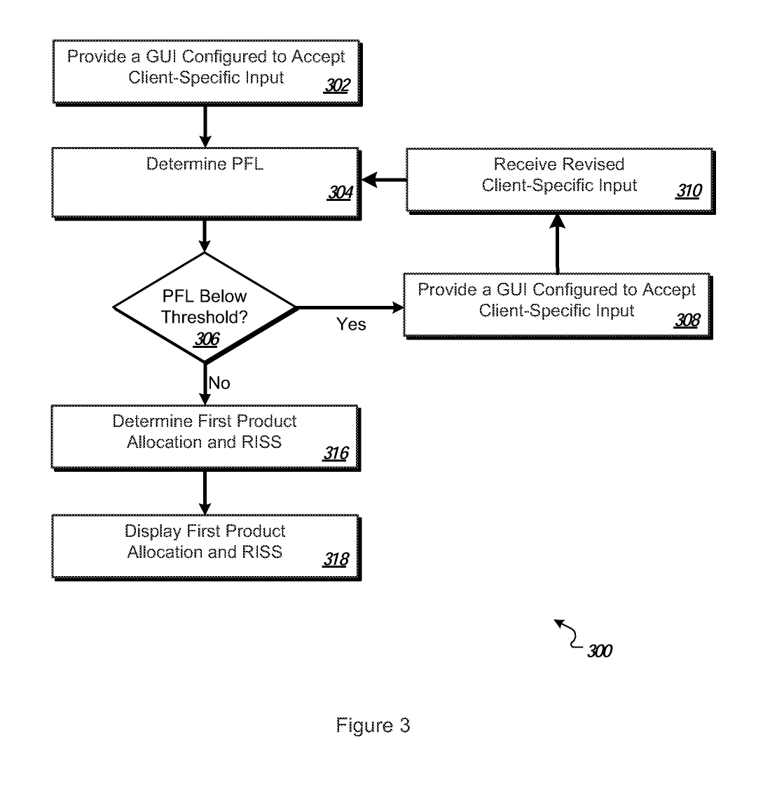

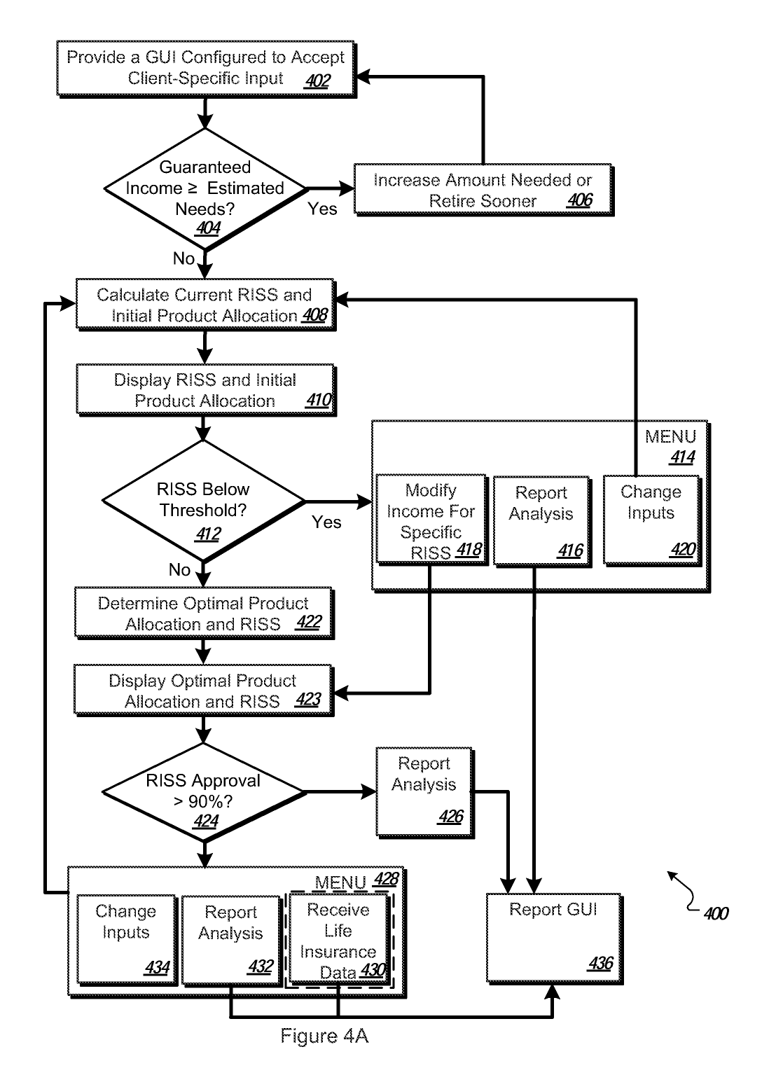

FIG. 3 illustrates, in accordance with some implementations, a method (300), performed by a processor of a computing device, for performing an analysis of sustainability of an investment portfolio to support a retirement income need for a client and displaying a result of the analysis.

In some implementations, method (300) begins by providing a first GUI (GUI) configured to accept client-specific input (302). The GUI is configured to receive client-specific input via widgets.

The client-specific input includes at least one of: client age, client birth date, client birth year, client gender, desired number of years to retirement, desired retirement age, inflation, current income, amount of desired retirement income, estimated amount of one or more sources of guaranteed income such as pension, social security, or other sources of guaranteed income, “start at” age for each of the one or more sources of guaranteed income, and amount of planned expenses and/or deposits; client's initial total investment portfolio, also known as an initial product allocation, that includes cash, fixed income, and equity, and additional cash flows.

In some implementations, an PFL and/or a RISS are calculated (304). The calculated PFL and/or RISS may correspond to the initial allocation of the client's total investment portfolio or a reallocation of the current total investment portfolio that maximizes a computed RISS and/or PFL.

In some implementations, the PFL and/or RISS are compared to one or more predetermined thresholds (e.g. zero for PFL or 90% for RISS) (306). If the PFL and/or RISS are below the one or more predetermined thresholds, a menu is displayed comprising one or more GUI widgets for accepting one or more revised client-specific inputs (308). The revised client-specific inputs include, but are not limited to, a revised (e.g., upwardly revised) amount of current total investment portfolio; a revised (e.g., downwardly revised) amount of planned expenses; a revised (e.g., upwardly revised) desired number of years to retirement (or desired retirement age); and/or a revised (e.g., downwardly revised) amount of desired retirement income. After receiving the revised client-specific inputs (310), an updated RISS and/or PFL corresponding to the updated client-specific inputs are determined (304). The updated RISS and/or PFL are compared to the predetermined threshold (306) and this process is repeated until the RISS and/or PFL are no longer below the predetermined threshold.

In some implementations, a first (e.g., optimal) product allocation associated with the client-specific input is determined (316). The first product allocation is an allocation amount at least one of the following categories: investments (e.g. stocks, bonds, mutual funds, cash equivalents, and the like), variable annuities (e.g. variable annuities with lifetime income guaranteed), and immediate annuities (e.g. single premium immediate annuities). Additionally, the allocation in the category of investments may be further determined as a sub-allocation in the subcategories of cash, fixed income, and equity. The allocations in the category of variable annuities may be further determined as a sub-allocation in the subcategories of fixed income and equity. The allocation may be a current total investment portfolio corresponding to the client-specific input, or a reallocation of the current total investment portfolio that maximizes a computed RISS and/or PFL. In some implementations, the maximization may be subject to a restriction that the first product allocation contain a predetermined minimum amount (e.g. absolute or relative) of a first product silo (e.g. a total of cash and cash equivalents).

In some implementations, the first product allocation, maximized PFL, and/or maximized RISS are displayed (318) via the GUI. The first product allocation may be displayed as an allocation amount a plurality of asset categories. In some implementations, a measure of risk tolerance, a measure of importance of liquidity to the client, is determined and displayed with the first product allocation.

In some implementations, after displaying the product allocation (318), the processor provides GUI widgets (112), determines an updated RISS and/or PFL (114), if the GUI widgets are used to adjust the product allocation, and displays an updated RISS and/or PFL (116) as described in relation to FIG. 1.

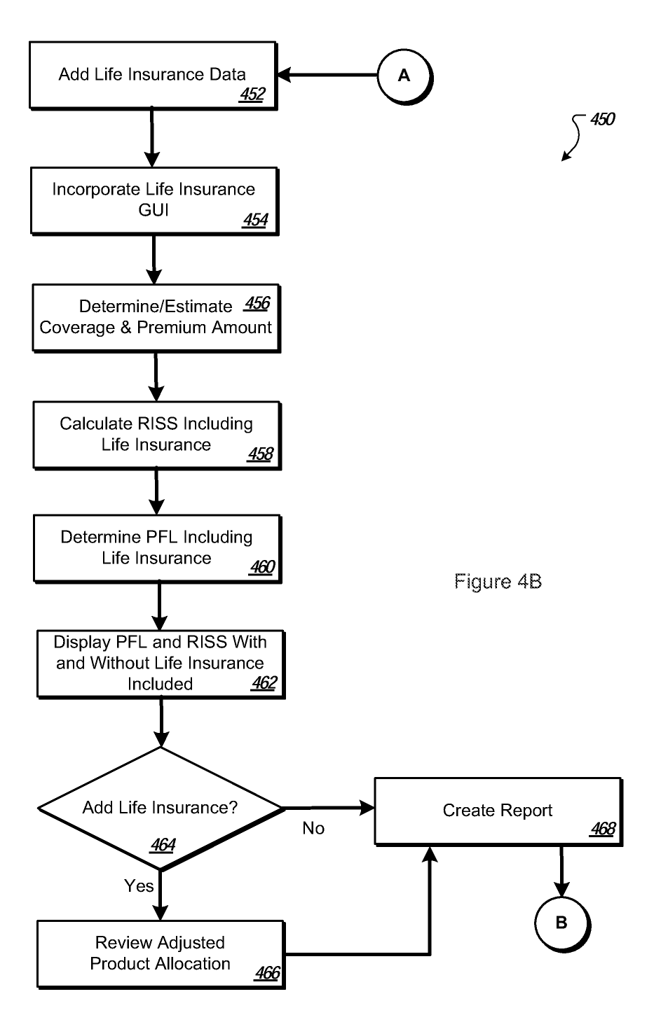

FIG. 4A illustrates, in accordance with some implementations, a method (400), performed by a processor of a computing device, for performing an analysis of sustainability of an investment portfolio to support a retirement income need for a client and displaying a result of the analysis.

In some implementations, method (400) begins by providing a first GUI (GUI) configured to accept client-specific input (402). The GUI is configured to receive client-specific input via widgets. The client-specific input includes at least one of: client age, client birth date, client birth year, client gender, desired number of years to retirement, desired retirement age, inflation, current income, amount of desired retirement income, estimated amount of one or more sources of guaranteed income such as pension, social security, or other sources of guaranteed income, ‘“start at” age for each of the one or more sources of guaranteed income, and amount of planned expenses and/or deposits; client's initial total investment portfolio, also known as an initial product allocation, that includes cash, fixed income, and equity, and additional cash flows.

In some implementations, the guaranteed income is compared to the amount of desired retirement income (404). If the amount of guaranteed income meets or exceeds the estimated needs, the processor prompts the user to increase the amount of desired retirement income or to decrease the desired number of years to retirement (406). The prompt may include, but is not limited to, a message telling the user to increase the amount of desired retirement income or to decrease the desired number of years to retirement, one or more data entry fields that enable at least one of the client-specific inputs to be changed, and/or displaying the first GUI (402) such that the client-specific inputs can be changed.

In some implementations, if the guaranteed income does not meet or exceed a predetermined percentage of the estimated client retirement income needs when the guaranteed income is compared to the amount of desired retirement income (404), the current RISS and/or PFL are calculated (408). The current RISS and/or PFL corresponding to the client-specific input are displayed via the first GUI (410). Additionally, the asset allocation breakdown (e.g. cash, fixed income, equity) may be displayed with the RISS and/or PFL.

In some implementations, the RISS and/or PFL are compared to a first threshold (412). For example, the RISS threshold may be 90% and/or the PFL threshold may be $0. Other thresholds may be set. The comparison may utilize a PFL and/or RISS corresponding to the initial allocation of the client's total investment portfolio or a reallocation of the current total investment portfolio that maximizes a computed RISS and/or PFL.

If the RISS and/or PFL are below the first threshold, a menu is displayed (414). The menu may include, but is not limited to, an option to report analysis (416), an option to modify the client-specific income need to a predetermined amount to provide a specific RISS and/or PFL value (418), an option for the user to change the client-specific inputs (420), and/or an option to increase the amount of time to retirement to provide a specific RISS and/or PFL.

In some implementations, the option for the user to change the client-specific inputs (420) includes a second GUI such that the client-specific inputs can be changed. The client-specific inputs that may be changed include, but are not limited to, increasing retirement savings, reducing the estimated retirement income need, and/or working longer and retiring later. After changing the inputs, the processor returns to step 408.

In some implementations, selecting the option to modify the client-specific income need to a predetermined amount to provide a specific RISS and/or PFL value (418) displays the current RISS and/or PFL and a corresponding product allocation (410) based on the modified client-specific income need.

In some implementations, report analysis (416) provides a GUI that enables a user to create a report (436).

In some implementations, if the RISS and/or PFL meet or exceed the first threshold when the RISS and/or PFL are compared to the first threshold (412), a first product allocation associated with the client-specific input is determined (422). The allocation can be the current investment portfolio or a reallocation of the current total investment portfolio that maximizes a computed RISS, PFL, or other variable. The computed product allocation and RISS may then be displayed (423).

In some implementations, the RISS and/or PFL are compared to a second threshold (424). If the RISS and/or PFL are below the second threshold (e.g. 90%), an option to report analysis is displayed (426). Selecting report analysis (426) provides a GUI that enables a user to create a report (436).

In some implementations, if the RISS and/or PFL meet or exceed the second threshold (e.g. 90%), a menu is displayed (428). The menu may include, but is not limited to, an option to add life insurance data (430), an option to report analysis (432), and an option to change the client specific inputs (434). In some implementations, the option to add life insurance will not be included.

The option to change the client-specific inputs (434) provides a GUI that enables a user to change the desired gross income at retirement. Submission of a new desired gross income at retirement results in calculation of the current RISS and/or PFL corresponding to the new desired gross income at retirement.

The option to report analysis (432) provides a GUI that enables a user to create a report (436).

The option to receive life insurance data (430) provides a GUI where a user can input the life insurance data, recalculate RISS and PFL based on the life insurance data, and compare RISS and PFL with and without the life insurance data factored into the calculation. The method of receiving life insurance data is described with reference to FIG. 4B.

In some implementations, the report GUI (436) provides a graphic user interface for the input of additional client-specific input and create an analysis report of sustainability of an investment portfolio to support a retirement income need for a client and displaying a result of the analysis. The additional client-specific input includes, but is not limited to, advisor information and client information. Advisor information includes, but is not limited to, first name, last name, office number, cell phone number, fax number, email address, firm name, and firm address. Client information includes, but is not limited to, first name and last name of one or more clients.

FIG. 4B illustrates, in accordance with some implementations, a method (450), performed by a processor of a computing device, for receiving life insurance data and the impact life insurance has on the analysis of sustainability of an investment portfolio to support a retirement income need for a client and displaying a result of the analysis.

In some implementations, the method (450) of receiving life insurance data displays a GUI that enables a user to select whether they want to include their life insurance data in analyzing the sustainability of an investment portfolio (452).

In some implementations, after selecting to include life insurance data, an incorporate life insurance GUI is displayed (454). The incorporate life insurance GUI provides the ability to determine/estimate a client's coverage and premium amount (456). To determine/estimate a client's coverage and premium, the processor will provide the option of either determining a client's coverage and premium amount or inputting estimated coverage and premium amount.

If a user selects the option to determine a client's coverage and premium amount, the processor will provide one or more GUI widgets to enter insurance policy data. If the user selects the option to input estimated the coverage and premium amount, the processor will provide one or more of the GUI widgets to input life insurance policy data. Life insurance policy data includes, but is not limited to, annual life insurance premiums, the type of life insurance, whether the client is a smoker, the face amount of the insurance policy, a desired face amount of life insurance and/or an amount of a life insurance premium. Additionally, the processor may provide a proxy calculation for either the premium or the face amount of a life insurance policy. This proxy calculation may be based on a composite average for life insurance policies accounting for age, coverage type, smoker status, and either life insurance death benefit amount or an annual premium amount input and an underwriting class.

In some implementations, life insurance options may be restricted where the determined RISS is at least a pre-determined minimum value.

In some implementations, a RISS without life insurance and a RISS with life insurance are determined (458) according to the client-specific input.

In some implementations, a PFL without life insurance and a PFL with life insurance are determined (460) according to the client-specific input.

In some implementations, the PFL with life insurance, the PFL without life insurance, the RISS with life insurance, and the RISS without life insurance are displayed (462).

In some implementations, the user is provided a GUI to select whether they want to add life insurance (464) after the RISS and/or PFL are displayed (462). If the processor receives a command to add life insurance, a review adjusted product allocation with life insurance GUI is provided (466). If the processor receives a command to not add life insurance, the option to report analysis is provided to the user (468). The option to report analysis (468) provides a GUI that enables a user to create a report.

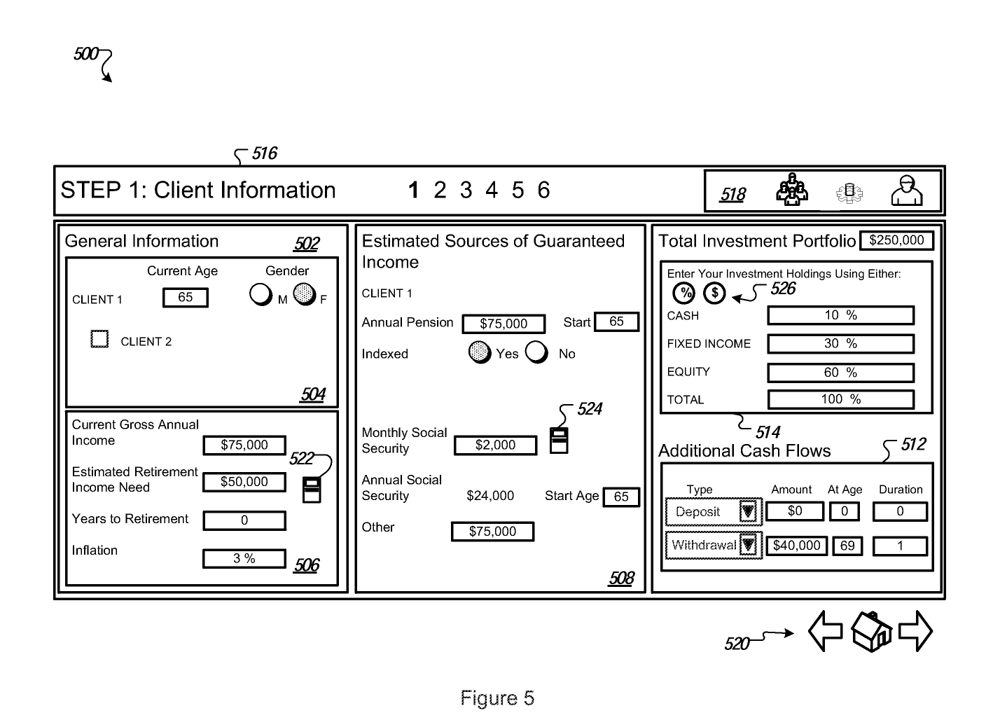

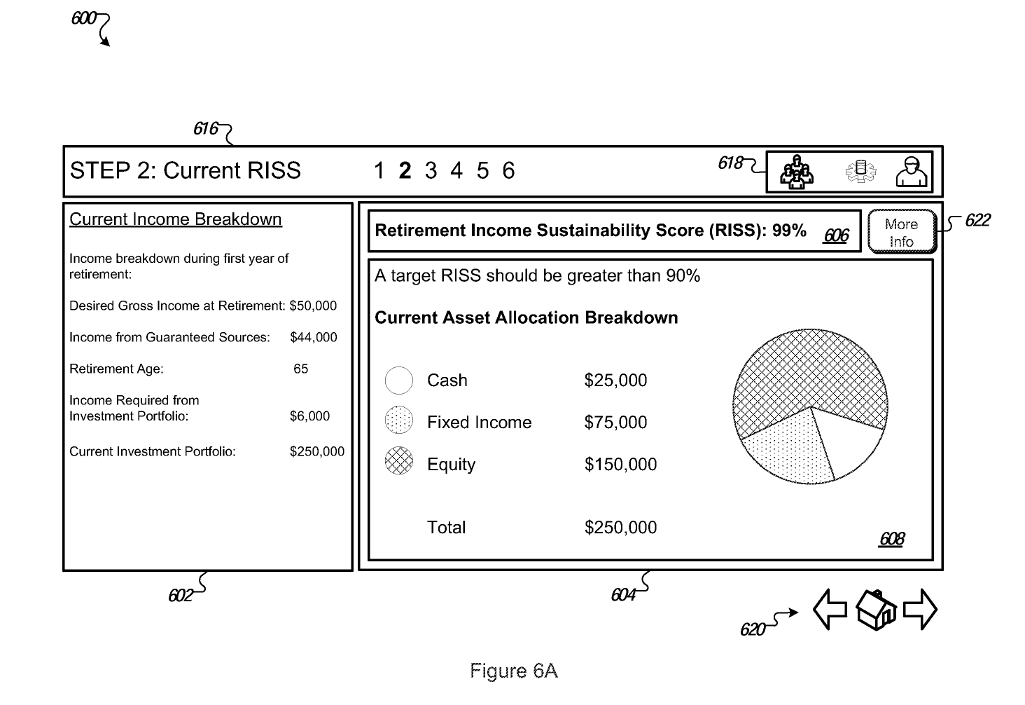

FIG. 5 illustrates, in accordance with some implementations, a GUI (500) configured to accept client-specific input. The client-specific input includes, but is not limited to: general information (502), estimated sources of guaranteed income information (508), total investment portfolio information (514), and additional cash flow information (512).

The general information (502), estimated sources of guaranteed income (508), total investment portfolio information (514), and additional cash flow information (512) may be inputted to the processor via the GUI (500). The GUI (500) may include a variety of widgets for each type of information.

In some implementations, the general information (502) includes, but is not limited to, client background information (504) and client retirement information (506). Client background information (504) may include, but is not limited to, client age, birth date, birth year, and/or gender. Client retirement information (506) may include, but is not limited to, current gross annual income, estimated retirement income need, desired number of years to retirement, and inflation. Additionally, client retirement information (506) may include an expense calculator (522). The expense calculator (522) incorporates data to assist client in assessing their specific retirement needs. The data may consist of data collected from the Bureau of Labor Statistics Consumer Expenditure Survey (CES), which provides users with a starting budget for a client based on the spending habits of American households. This data may also be customized to further make it client specific.

The estimated sources of guaranteed income are the sources of income clients are guaranteed to receive as long as they live. The estimated sources of guaranteed income information (508) may include, but is not limited to, pension, whether a pension is indexed to inflation, social security, other sources of guaranteed income, and a “start age” for each of the one or more sources of guaranteed income. Other sources of guaranteed income include, but are not limited to, immediate annuities or income from variable annuities.

For example, a first client may have a defined pension of $75,000 per year and it is indexed to inflation. This means that his pension will increase every year by the 3% inflation rate chosen earlier. As his pension started when he retired at age 65, the “start age” will also be 65 as shown in FIG. 5. If a client does not have a defined pension, the pension amount will be left at zero or blank.

In some implementations, if a client knows how much monthly income to expect from social security, this amount can be manually entered. However, if a client does not known how much monthly income they can expect to receive, the estimated sources of guaranteed income information (508) may include a calculator (524) for estimating a client's social security benefit. The calculator may provide the user with a new GUI, such as a pop-up calculator or a new GUI page. Additionally, the calculator may redirect the user to a calculator on the Social Security Administration website to calculate an estimated social security benefit.

In some implementations, the total investment portfolio information (514) may include, but is not limited to, an amount of current total investment portfolio, a breakdown of the current total investment portfolio based on percentage or value. The user can toggle between a percentage view or dollar value based view of the breakdown of their current total investment portfolio using a widget. For example, the total investment portfolio may be set to an asset value of $250,000. A user may select an icon or button representing a percent or dollar amount. These two icons (526) allow a user to enter client portfolio details in dollar amounts or as percentage of total assets. In some implementations, depending on which icon is selected, the cash, fixed income, and equity sections will auto-populate based on the default settings (e.g. cash set to 10%, fixed income set to 30%, and equity set to 60%).

In some implementations, the additional cash flow information (512) may include, but is not limited to, the amount of planned expenses (withdrawals) or deposits. Users can enter the amount of any deposit or withdrawal, the age at which the deposit or withdrawal will occur, and the duration of the deposit or withdrawal. The duration is based on whether the deposit or withdrawal is recurring.

For example, if a client wanted to renovate their house in three years, the cost of renovating the house would be entered as a withdrawal. Continuing with the example discussed above, assume the cost of the renovation was $40,000, the renovation is happening in 4 years, and the renovation will last 1 year. In this example, the user would enter the “amount” of the withdrawal as $40,000, the “at age” as 69, and the “duration” as 1 as shown in FIG. 5.

In some implementations, the additional cash flows section can support all known ad-hoc revenues as well as expenses. For example, if a client continued working part-time and received an income until she was 70, this could be illustrated by including the estimated amount of income as a deposit “amount”, 65 in the “at age” box, and 5 years in the “duration” box.

In some implementations, the GUI (500) also provides navigation buttons (520). Navigation buttons (520) may include, but are not limited to, forward, backward, and/or home buttons.

In some implementations, the GUI (500) also provides a status bar (516). The status bar communicates the user's progress with the determining the sustainability of their investment portfolio.

In some implementations, the GUI (500) may also provide a navigation bar (518). The navigation bar may include additional navigation buttons including buttons for client profiles, preferences, and contacts.

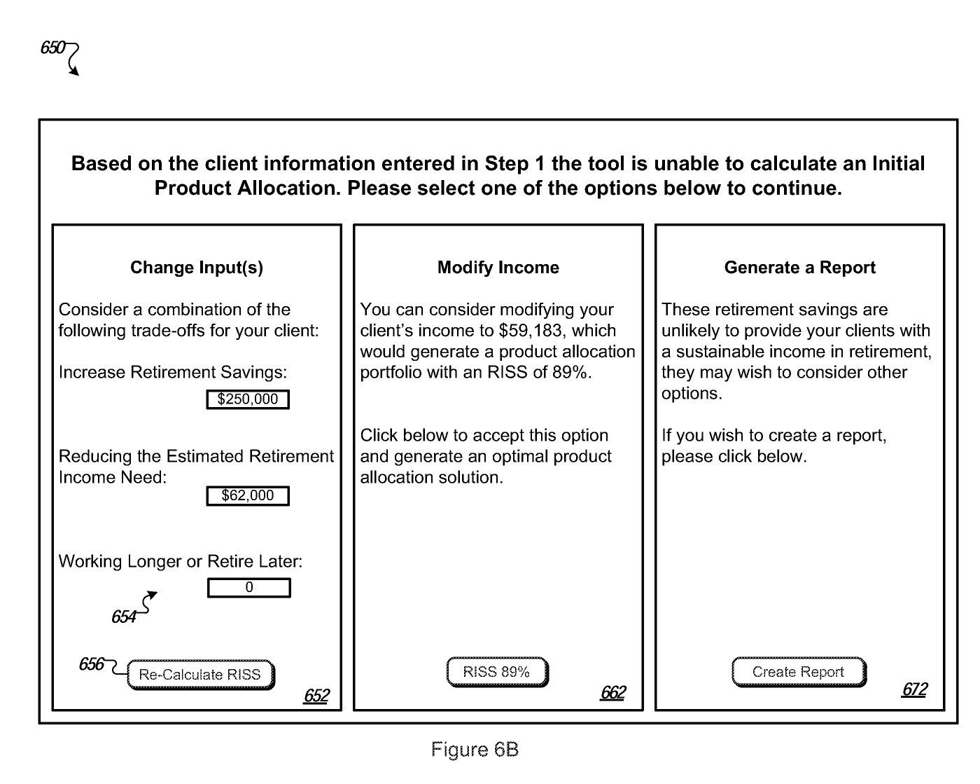

FIG. 6A illustrates, in accordance with some implementations, a GUI (600) configured to provide a current income breakdown (602) and sustainability information (604). Sustainability information measures how sustainable a client's estimated retirement spending is likely to be over their lifetime. Taking into account client and portfolio characteristics, the processor computes RISS and/or PFL and displays the results of the computation in GUI (600).

In some implementations, the current income breakdown (602) may include, but is not limited to, an income breakdown during the first year of retirement. The breakdown may include the desired gross income at retirement, income from guaranteed sources, retirement age, the income from investments portfolio, and/or the current investment portfolio value. The breakdown may also include other client-specific information discussed in relation to FIG. 5.

In some implementations, the sustainability information (604) may include, but is not limited to, a RISS (606), a current asset breakdown (608), and a more information widget (622). The current asset breakdown (608) provides a breakdown of the current assets in the client's total investment portfolio including cash, fixed income, and equity. The current asset breakdown (608) may include a pie chart, plot, graph, or as text listing the current amount allocated to cash, fixed income, equity, and total current assets as a percent or as a dollar value. The more information widget (622) provides a user an explanation of the RISS value. The more information widget (622) may include, but is not limited to, a button or an active field that presents information when highlighted.

In some implementations, the GUI (600) also provides navigation buttons (620). Navigation buttons (620) may include, but are not limited to, forward, backward, and/or home buttons.

In some implementations, the GUI (600) also provides a status bar (616). The status bar communicates the user's progress with the determining the sustainability of their investment portfolio.

In some implementations, the GUI (600) may also provide a navigation bar (618). The navigation bar may include additional navigation buttons including buttons for client profiles, preferences, and contacts.

FIG. 6B illustrates, in accordance with some implementations, a menu GUI (650), configured to provide an analysis of sustainability of an investment portfolio to support a retirement income need for a client.

In some implementations, when a user selects the “next” navigation button from the navigation buttons (620, FIG. 6A), the processor compares the RISS and/or PFL to a first threshold. For example, the RISS threshold may be 90% and/or the PFL threshold may be $0. Other thresholds may be set. If the RISS and/or PFL below the first threshold, a menu GUI (650) is displayed. The menu may include, but is not limited to, an option to report analysis (672), an option to modify the client-specific income need to a predetermined amount to provide a specific RISS and/or PFL value (662), and/or an option for the user to change the client-specific inputs (652).

In some implementations, the option for the user to change the client-specific inputs (652) provides the user the ability to adjust at least one of the client-specific inputs described in relation to FIG. 5, including increasing retirement savings, reducing the estimated retirement income need, and/or working longer and retiring later. These values may be changed using one or more widgets (654) that enable a user to adjust the client-specific inputs. If any of these values are changed, you can recalculate the RISS, PFL, and/or a new product allocation by selecting a recalculate widget (656).

In some implementations, if a user selects the option to modify the client-specific income need to a predetermined amount to provide a specific RISS and/or PFL value (662), the processor will generate a new current product allocation solution based on the modified income level. The processor will display GUI (600, FIG. 6A) based on the modified income need which provides a specific RISS and/or PFL.

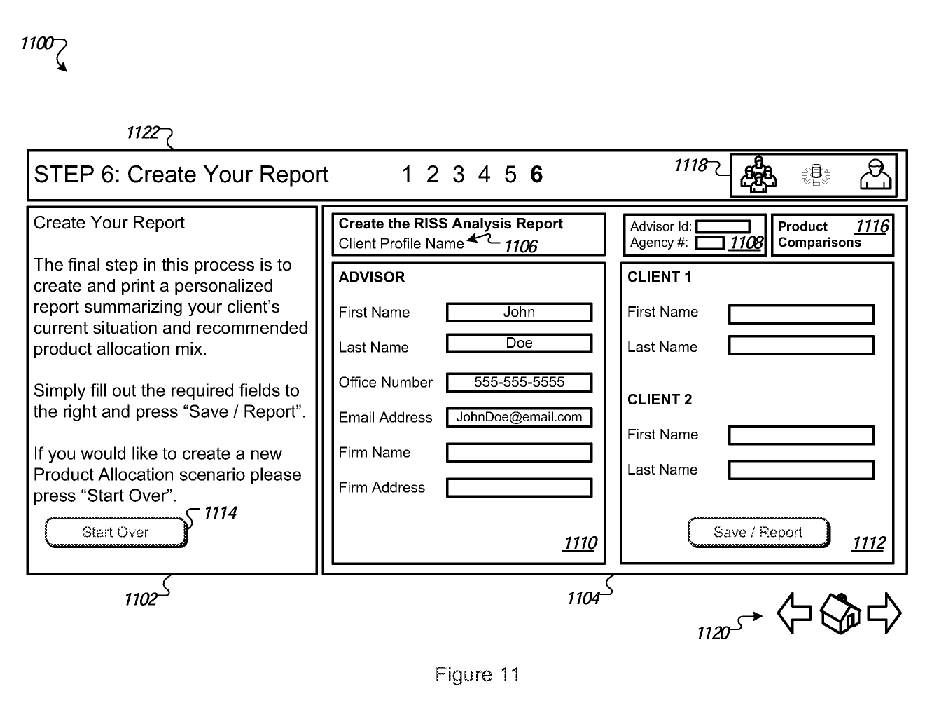

In some implementations, report analysis (672) provides a GUI that enables a user to create a report. The GUI used to create reports is described in relation to FIG. 11.

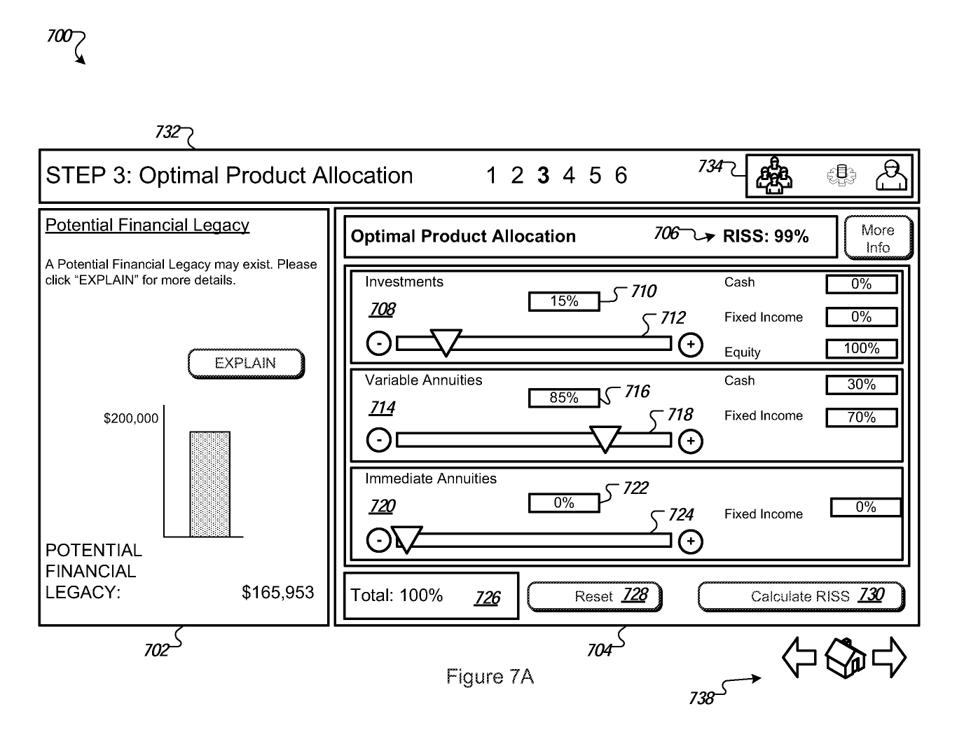

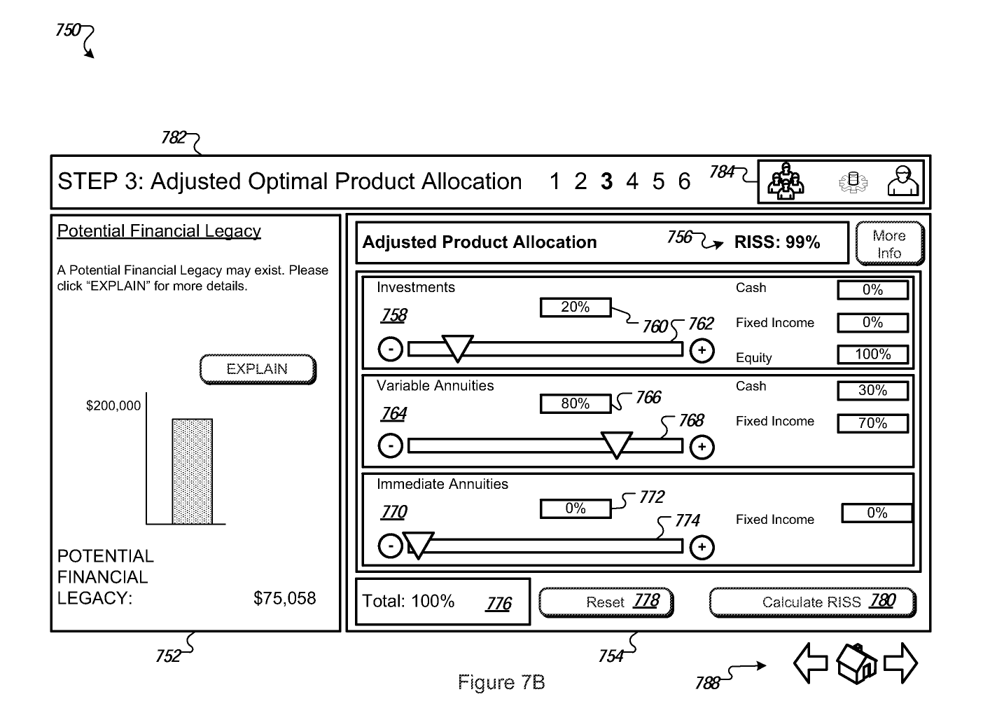

FIG. 7A illustrates, in accordance with some implementations, a GUI (700) configured to provide an optimal product allocation solution based on the client-specific information provided in reference to FIG. 5. The optimal product allocation is calculated on the basis of maximizing the retirement income sustainability using demographic characteristics and financial circumstances. If multiple product allocations would result in the same maximized income sustainability, the optimal product allocation will be the one with the highest PFL value.

This solution shows the optimal allocation to the three product categories. In this example, 15% is allocated to investments (710), 85% is allocated to variable annuities (716), and 0% is allocated to immediate annuities (722). The RISS corresponding to this allocation mixture is 99% (706). An RISS in this range indicates a very high likelihood that their desired retirement income will be sustainable for life provided they stick to the optimal product allocation.

A user has the option of adjusting the optimal product allocation mix using an optimal product allocation GUI (704). Clients may have individual preferences for liquidity, risk tolerance, and legacy. The optimal product allocation GUI (704) allows a user to tailor the optimal product allocation based on a specific client's preferences and circumstances.

The optimal product allocation GUI (704) includes an investment GUI (708), a variable annuity GUI (714), and an immediate annuity GUI (720). The investment GUI (708) includes an investment widget (712). In some implementations, the investment GUI (708) includes a data field box (710) where the user may manually enter a value that correlates to the percent of the assets allocated to investments. In some implementations, when the user adjusts the investment widget (712), the value in data field box (710) changes to reflect the adjustment made to the investment widget (712). Similarly, when the user adjusts the value in data field box (710), the investment widget (712) changes to reflect the adjustment made to the value in data field box (710). In some implementations, the investment GUI (708) provides a breakdown of the investment allocation based on cash, fixed income, and equity holdings. These allocations can be adjusted manually by the user.

The variable annuity GUI (714) includes an variable annuity widget (718). In some implementations, the variable annuity GUI (714) includes a data field box (716) where the user may manually enter a value that correlates to the percent of the assets allocated to investments. In some implementations, when the user adjusts the variable annuity widget (718), the value in data field box (716) changes to reflect the adjustment made to the variable annuity widget (718). Similarly, when the user adjusts the value in data field box (716), the variable annuity widget (718) changes to reflect the adjustment made to the value in data field box (716). In some implementations, the variable annuity GUI (714) provides a breakdown of the investment allocation based on fixed income and equity holdings. These allocations can be adjusted manually by the user.

The immediate annuity GUI (720) includes an immediate annuity widget (724). In some implementations, the immediate annuity GUI (720) includes a data field box (722) where the user may manually enter a value that correlates to the percent of the assets allocated to investments. In some implementations, when the user adjusts the immediate annuity widget (724), the value in data field box (722) changes to reflect the adjustment made to the immediate annuity widget (724). Similarly, when the user adjusts the value in data field box (722), the immediate annuity widget (724) changes to reflect the adjustment made to the value in data field box (722). In some implementations, the immediate annuity GUI (720) provides a breakdown of the investment allocation based on fixed income. When the user adjusts the value in data field box (722) or the immediate annuity widget (724), the breakdown of the investment allocated to fixed income changes accordingly.

In some implementations, the total product allocation (726) is the sum of percentage allocated to investments, variable annuities, and immediate annuities. As a user adjust the amount allocated to investments, variable annuities, and immediate annuities, allocation, the total product allocation (726) is displayed.

In some implementations, after adjusting the allocation mix, a user may select a calculate widget (730) to recalculate the RISS and/or PFL values and observe the effect on the client's new RISS and/or PFL. If the total product allocation (726) does not total 100% when a user attempts to recalculate the RISS and/or PFL, the user is provided with an error message stating that the total product allocation (726) is not 100%.

In some implementations, the RISS and/or PFL values are updated automatically and/or in real-time when a user adjusts the widgets (710, 712, 716, 718, 722, 724) to adjust the product allocation. In other implementations, the updated RISS may be determined when a user selects an option to update the RISS and/or (730). Typically a user would select to update the RISS after adjusting the widgets (710, 712, 716, 718, 722, 724). In some implementations, when the option to update the RISS (730) is selected, a GUI (750) is provided by the processor as shown in FIG. 7B. A description of GUI (750) is provided in relation to FIG. 7B below.

In some implementations, a user may also select a reset widget (728) to reset the allocation to the optimal product allocation originally presented to the user.

In some implementations, the graphical use interface (700) provides PFL information (702). The PFL information (702) may include a numeric value representing the PFL as well as a graph or plot showing the PFL value. In some implementations, the PFL information (702) may include a widget that provides additional information about the PFL value. In this example, the PFL is $165,953.

In some implementations, the GUI (700) also provides navigation buttons (738). Navigation buttons (738) may include, but are not limited to, forward, backward, and/or home buttons.

In some implementations, the GUI (700) also provides a status bar (732). The status bar communicates the user's progress determining the sustainability of their investment portfolio.

In some implementations, the GUI (700) may also provide a navigation bar (734). The navigation bar may include additional navigation buttons including buttons for client profiles, preferences, and contacts.

FIG. 7B illustrates, in accordance with some implementations, a GUI (750) configured to provide an adjusted optimal product allocation solution based on the client-specific information provided in reference to either FIG. 5 and/or FIG. 6B and adjustments made to the optimal product allocation using widgets described in relation to FIG. 7A.

This solution shows the adjusted optimal allocation to three product categories. In this example, 15% is allocated to investments (760), 85% is allocated to variable annuities (766), and 0% is allocated to immediate annuities (772). The RISS corresponding to this allocation mixture is 99% (756).

A user has the option of further adjusting the adjusting optimal product allocation mix using an adjusted optimal product allocation GUI (754). Clients may have individual preferences for liquidity, risk tolerance, and PFL. The adjusted optimal product allocation GUI (754) allows a user to tailor the optimal product allocation based on a specific client's preferences and circumstances.

The adjusted optimal product allocation GUI (754) includes an investment GUI (758), a variable annuity GUI (764), and an immediate annuity GUI (770). The investment GUI (758) includes an investment widget (762). In some implementations, the investment GUI (758) includes a data field box (760) where the user may manually enter a value that correlates to the percent of the assets allocated to investments. In some implementations, when the user adjusts the investment widget (762), the value in data field box (760) changes to reflect the adjustment made to the investment widget (762). Similarly, when the user adjusts the value in data field box (760), the investment widget (762) changes to reflect the adjustment made to the value in data field box (760). In some implementations, the investment GUI (758) provides a breakdown of the investment allocation based on cash, fixed income, and equity holdings. These allocations can be adjusted manually by the user.

The variable annuity GUI (764) includes an variable annuity widget (768). In some implementations, the variable annuity GUI (764) includes a data field box (766) where the user may manually enter a value that correlates to the percent of the assets allocated to investments. In some implementations, when the user adjusts the variable annuity widget (768), the value in data field box (766) changes to reflect the adjustment made to the variable annuity widget (768). Similarly, when the user adjusts the value in data field box (766), the variable annuity widget (768) changes to reflect the adjustment made to the value in data field box (766). In some implementations, the variable annuity GUI (764) provides a breakdown of the investment allocation based on fixed income and equity holdings. These allocations can be adjusted manually by the user.

The immediate annuity GUI (770) includes an immediate annuity widget (774). In some implementations, the immediate annuity GUI (770) includes a data field box (772) where the user may manually enter a value that correlates to the percent of the assets allocated to investments. In some implementations, when the user adjusts the immediate annuity widget (774), the value in data field box (772) changes to reflect the adjustment made to the immediate annuity widget (774). Similarly, when the user adjusts the value in data field box (772), the immediate annuity widget (774) changes to reflect the adjustment made to the value in data field box (772). In some implementations, the immediate annuity GUI (770) provides a breakdown of the investment allocation based on fixed income. When the user adjusts the value in data field box (772) or the immediate annuity widget (774), the breakdown of the investment allocated to fixed income changes accordingly.

In some implementations, the total product allocation (776) is the sum of percentage allocated to investments, variable annuities, and immediate annuities. As a user adjust the amount allocated to investments, variable annuities, and immediate annuities, allocation, the total product allocation (776) is displayed.

In some implementations, after adjusting the allocation mix, a user may select a calculate widget (780) to recalculate the RISS and/or PFL values and observe the effect on the client's new RISS and/or PFL. If the total product allocation (776) does not total 100% when a user attempts to recalculate the RISS and/or PFL, the user is provided with an error message stating that the total product allocation (776) is not 100%.

In some implementations, the RISS and/or PFL values are updated automatically and/or in real-time when a user adjusts the widgets (760, 762,766, 768, 772, 774) to adjust the product allocation. In other implementations, the updated RISS and/or PFL may be determined when a user selects an option to update the RISS (780). Typically a user would select to update the RISS after adjusting the widgets (760, 762,766, 768, 772, 774). In some implementations, when the option to update the RISS (780) is selected, a the GUI (750) is updated using the adjusted values to calculate the updated RISS.

In some implementations, a user may also select a reset widget (778) to reset the allocation to the optimal product allocation originally presented to the user.

In some implementations, the graphical use interface (750) provides PFL information (752). The PFL information (752) may include a numeric value representing the PFL as well as a graph or plot showing the PFL value. In some implementations, the PFL information (752) may include a widget that provides additional information about the PFL value.

In some implementations, the GUI (750) also provides navigation buttons (788). Navigation buttons (788) may include, but are not limited to, forward, backward, and/or home buttons.

In some implementations, the GUI (750) also provides a status bar (782). The status bar communicates the user's progress determining the sustainability of their investment portfolio.

In some implementations, the GUI (750) may also provide a navigation bar (784). The navigation bar may include additional navigation buttons including buttons for client profiles, preferences, and contacts.

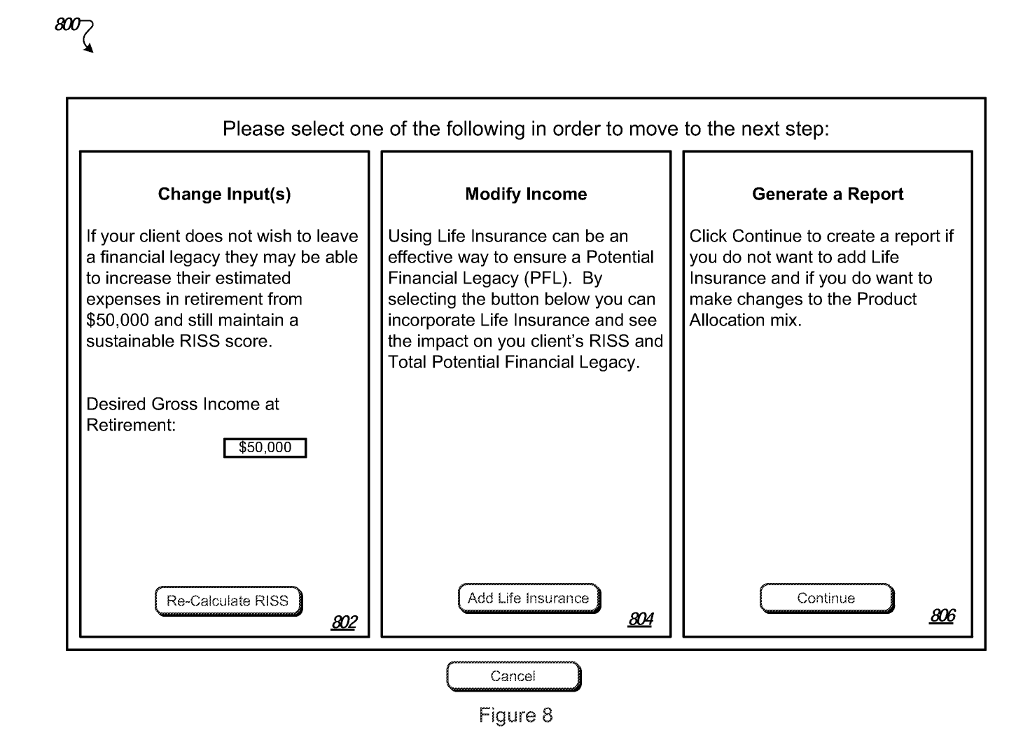

FIG. 8 illustrates, in accordance with some implementations, a GUI (800) configured to provide a user the ability to modify the analysis of sustainability of an investment portfolio to support a retirement income need for a client and displaying a result of the analysis.

In some implementations, the graphical interface (800) may include an option to change client-specific inputs (802), an option to add life insurance (804), and an option to generate a report (806).

The option to change the client-specific inputs (802) provides a GUI that enables a user to change the desired gross income at retirement. Submission of a new desired gross income at retirement results in calculation of the current RISS and/or PFL corresponding to the new desired gross income at retirement.

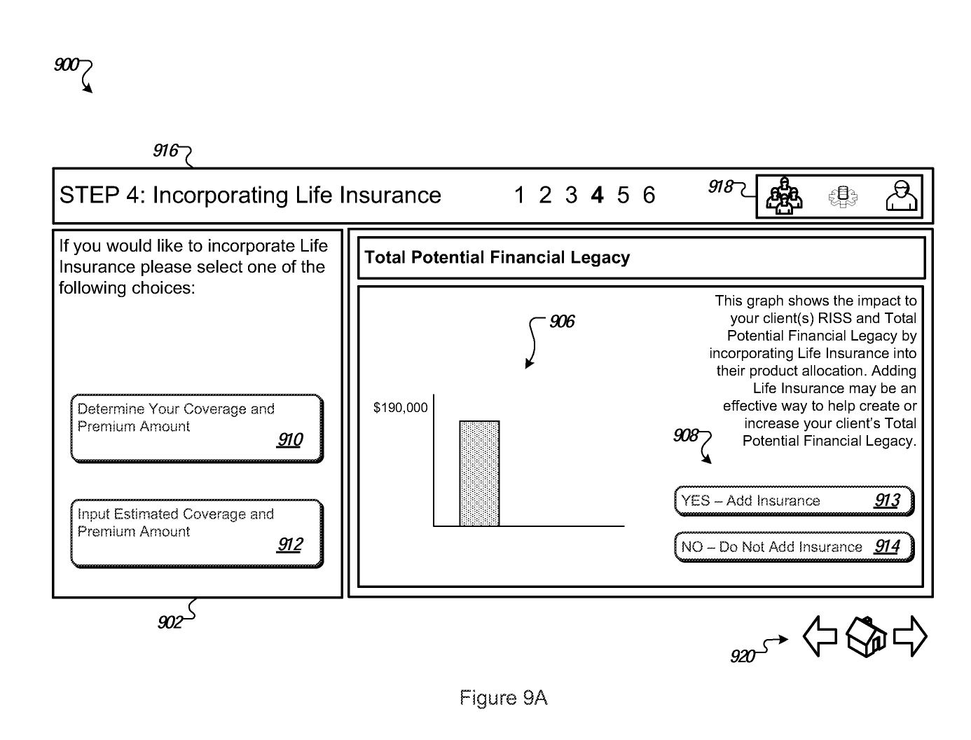

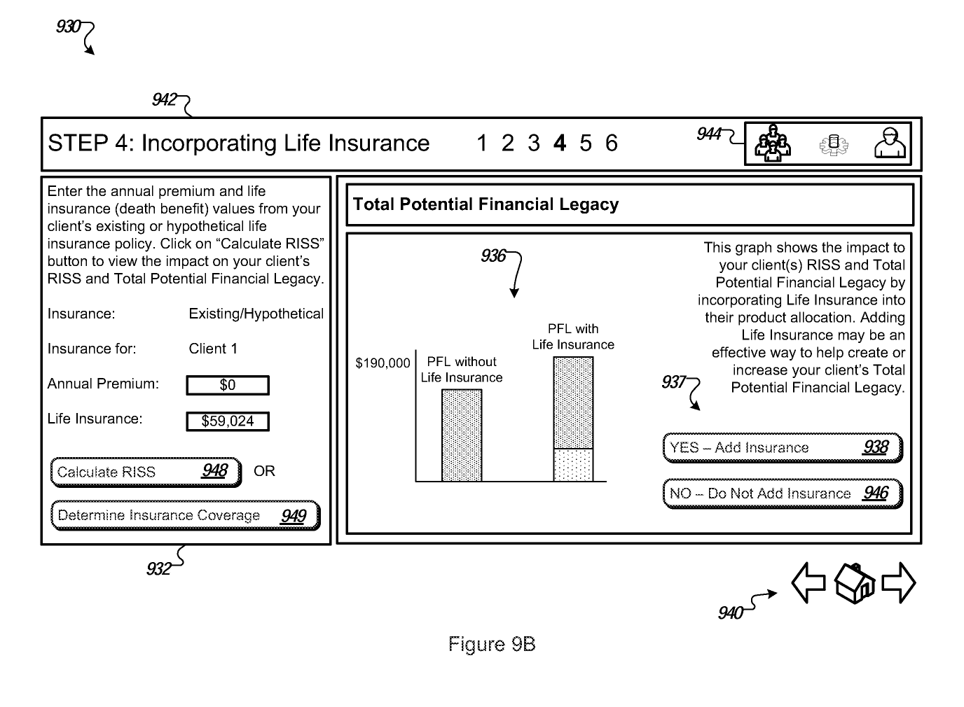

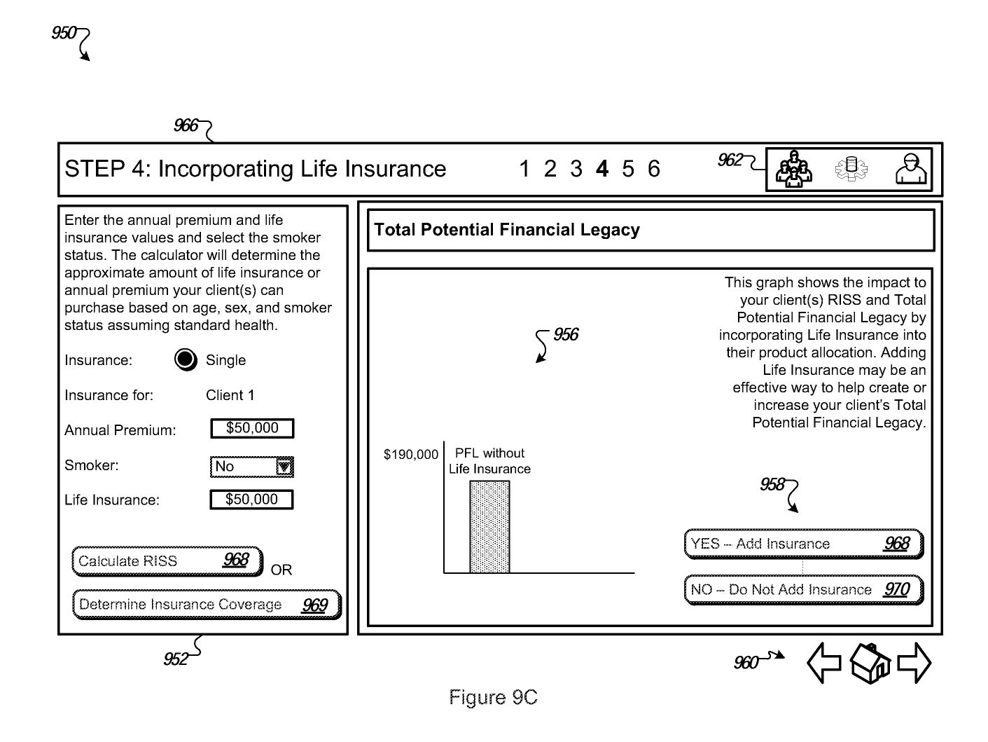

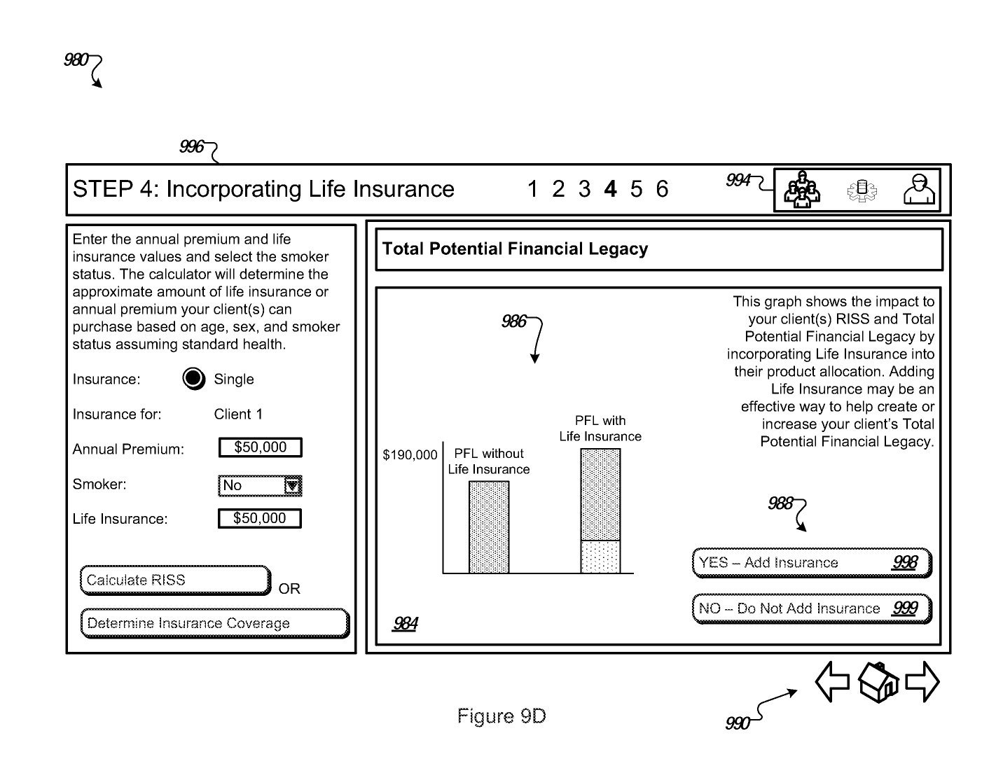

The option to receive life insurance data (804) provides a GUI where a user can input the life insurance data, recalculate RISS and/or PFL based on the life insurance data, and compare RISS and/or PFL with and without the life insurance data factored into the calculation (see description of FIGS. 9A, 9B, and 9C below).

The option to report analysis (806) provides a GUI that enables a user to create a report (see description of FIG. 11 below). In some implementations, the report GUI provides a graphic user interface for the input of additional client-specific input and create an analysis report of sustainability of an investment portfolio to support a retirement income need for a client and displaying a result of the analysis. The additional client-specific input includes, but is not limited to, advisor information and client information. Advisor information includes, but is not limited to, first name, last name, office number, cell phone number, fax number, email address, firm name, and firm address. Client information includes, but is not limited to, first name and last name of one or more clients.

FIG. 9A illustrates, in accordance with some implementations, a GUI (900) configured to provide sustainability information and enable a user to add or decline to add life insurance to the analysis of sustainability of an investment portfolio to support a retirement income need for a client.

After selecting to include life insurance data (see 804 in FIG. 8), the GUI (900) is displayed. In some implementations, the GUI (900) includes a life insurance GUI (902). The life insurance GUI provides one or more GUI widgets (910 & 912). The GUI widgets may include a first widget (910) for determining an amount of a life insurance premium and a second widget (912) for inputting a desired face amount of life insurance. Selecting the first widget (910) provides a GUI display as described in relation to FIG. 9C below. Selecting the second widget (912) provides a GUI display as described in relation to FIG. 9B below.

GUI (900) may include one or more add insurance GUI widgets (908). Add insurance GUI widgets (908) may include an first add insurance GUI widget (912) for including life insurance in the analysis of sustainability of an investment portfolio to support a retirement income need for a client and displaying a result of the analysis. Add insurance GUI widgets (908) may include an second add insurance GUI widget (914) for excluding life insurance in the analysis of sustainability of an investment portfolio to support a retirement income need for a client and displaying a result of the analysis.

In some implementations, the GUI (900) includes a graphic (906) that reflects the PFL without life insurance. The graphic (906) may include a plot, chart, or graph.

In some implementations, the GUI (900) also provides navigation buttons (920). Navigation buttons (920) may include, but are not limited to, forward, backward, and/or home buttons.

In some implementations, the GUI (900) also provides a status bar (916). The status bar communicates the user's progress determining the sustainability of their investment portfolio.

In some implementations, the GUI (900) may also provide a navigation bar (918). The navigation bar may include additional navigation buttons including buttons for client profiles, preferences, and contacts.

FIG. 9B illustrates, in accordance with some implementations, a GUI (930) configured to receive an estimate of the amount of a life insurance premium. This GUI provides users the ability to enter life insurance premium and policy information based on a client's existing or hypothetical life insurance plan.

The GUI (930) includes an estimate insurance GUI (932) where a use may enter the annual premium or life insurance values.

In some implementations, the estimate insurance GUI (932) may include a calculate RISS widget (948). When a user selects this widget, they will be provided a GUI as discussed in relation to FIG. 9D.

In some implementations, the estimate insurance GUI (932) may include a determine life insurance widget (949). When a user selects this widget they will be provided a GUI as discussed in FIG. 9C.

In some implementations, the GUI (930) includes a graphic (936) that reflects the PFL without life insurance and/or the PFL with life insurance. The graphic (936) may include a plot, chart, or graph.

The GUI (930) may include one or more add insurance GUI widgets (937). Add insurance GUI widgets (937) may include an first add insurance GUI widget (938) for including life insurance in the analysis of sustainability of an investment portfolio to support a retirement income need for a client and displaying a result of the analysis. Add insurance GUI widgets (937) may include an second add insurance GUI widget (946) for excluding life insurance in the analysis of sustainability of an investment portfolio to support a retirement income need for a client and displaying a result of the analysis.

In some implementations, the GUI (930) also provides navigation buttons (940). Navigation buttons (940) may include, but are not limited to, forward, backward, and/or home buttons.

In some implementations, the GUI (930) also provides a status bar (942). The status bar communicates the user's progress determining the sustainability of their investment portfolio.

In some implementations, the GUI (930) may also provide a navigation bar (944). The navigation bar may include additional navigation buttons including buttons for client profiles, preferences, and contacts.

FIG. 9C illustrates, in accordance with some implementations, a GUI (950) configured to determine the amount of a life insurance premium. The determine coverage GUI (952) will determine the approximate amount of life insurance or annual premium the client(s) can purchase based on age, coverage type, smoker status, and an underwriting class.

The GUI (950) includes a determine coverage GUI (952) where a user may enter the annual premium or life insurance values, and select whether they are a smoker. In some implementations, the determine coverage GUI (952) may include a calculate RISS widget (968). When a user selects this widget, they will be provided a GUI as discussed in relation to FIG. 9D.

In some implementations, the determine coverage GUI (952) may include an incorporate life insurance widget (969). When a user selects this widget they will be provided a GUI as discussed in FIG. 9B.

In some implementations, the GUI (950) includes a graphic (956) that reflects the PFL without life insurance. The graphic (956) may include a plot, chart, or graph.

GUI (950) may include one or more add insurance GUI widgets (958). Add insurance GUI widgets (958) may include an first add insurance GUI widget (968) for including life insurance in the analysis of sustainability of an investment portfolio to support a retirement income need for a client and displaying a result of the analysis. Add insurance GUI widgets (958) may include an second add insurance GUI widget (970) for excluding life insurance in the analysis of sustainability of an investment portfolio to support a retirement income need for a client and displaying a result of the analysis.

In some implementations, the GUI (950) also provides navigation buttons (960). Navigation buttons (960) may include, but are not limited to, forward, backward, and/or home buttons.

In some implementations, the GUI (950) also provides a status bar (966). The status bar communicates the user's progress determining the sustainability of their investment portfolio.

In some implementations, the GUI (950) may also provide a navigation bar (962). The navigation bar may include additional navigation buttons including buttons for client profiles, preferences, and contacts.

FIG. 9D illustrates, in accordance with some implementations, a GUI (980) configured to provide sustainability information and enable a user to add or decline to add life insurance to the analysis of sustainability of an investment portfolio to support a retirement income need for a client.

If a user decides to incorporate life insurance using either the estimate insurance GUI (932, FIG. 9B) or the determine coverage GUI (952, FIG. 9C), the user will be provided with the GUI (980) when they select the calculate RISS widget (948 in Figure B, 968 in Figure C). Additionally, when the use selects the calculate RISS widget (948 in Figure B, 968 in Figure C), a PFL without life insurance, a PFL with life insurance, a RISS without life insurance and a RISS with life insurance are determined.

The GUI (980) provides a comparison GUI (984). The comparison GUI may include a PFL comparison display (986) such as a graph, plot, or chart. The PFL comparison display (986) provides a visual representation to the user for comparing at least one of the PFL without life insurance, the PFL with life insurance, the RISS without life insurance and the RISS with life insurance.

GUI (980) may include one or more add insurance GUI widgets (988). Add insurance GUI widgets (988) may include an first add insurance GUI widget (998) for including life insurance in the analysis of sustainability of an investment portfolio to support a retirement income need for a client and displaying a result of the analysis. Add insurance GUI widgets (988) may include an second add insurance GUI widget (999) for excluding life insurance in the analysis of sustainability of an investment portfolio to support a retirement income need for a client and displaying a result of the analysis.

In some implementations, the GUI (980) also provides navigation buttons (990). Navigation buttons (990) may include, but are not limited to, forward, backward, and/or home buttons.

In some implementations, the GUI (980) also provides a status bar (996). The status bar communicates the user's progress determining the sustainability of their investment portfolio.

In some implementations, the GUI (980) may also provide a navigation bar (994). The navigation bar may include additional navigation buttons including buttons for client profiles, preferences, and contacts.

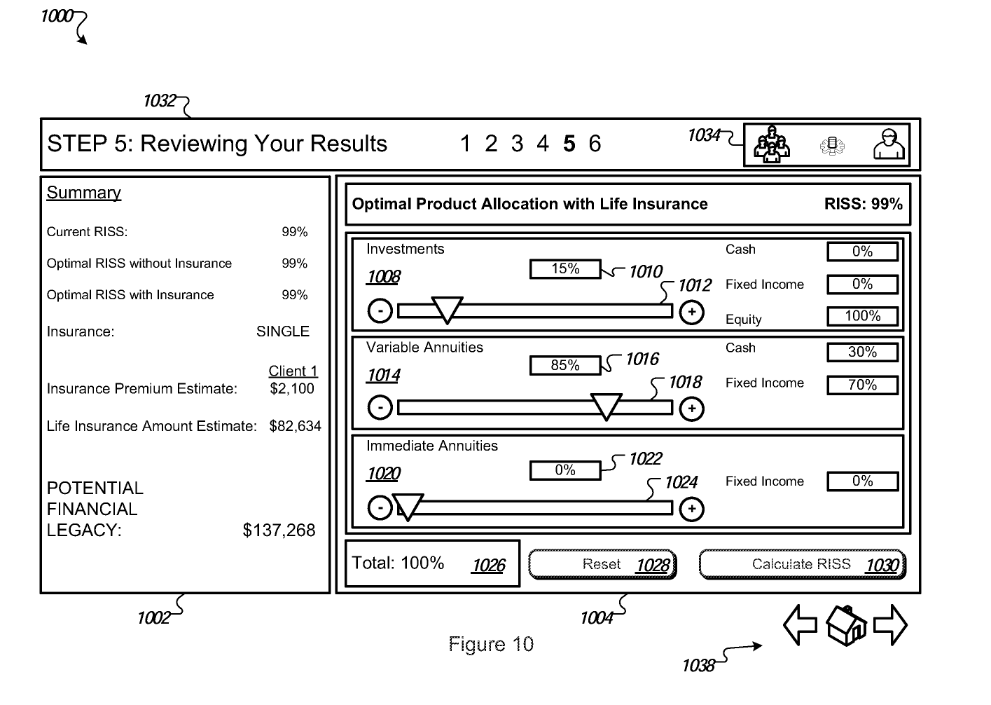

FIG. 10 illustrates, in accordance with some implementations, a GUI (1000) configured to provide an optimal product allocation with life insurance.

In some implementations, the graphical use interface (1000) provides summary information (1002). The summary information may include, but is not limited to, a current RISS, an optimal or adjusted RISS without insurance, an optimal or adjusted RISS with insurance, an insurance premium estimate and a life insurance amount estimate for one or more clients, and a PFL.

The PFL number is indicative of the approximate size of a possible legacy. The PFL may include a numeric value representing the PFL as well as a graph or plot showing the PFL value. In some implementations, the PFL information may include a widget that provides additional information about the PFL value. This widget may include, but is not limited to, a button or an active field that presents information when a cursor hovers over a designated area.

A user has the option of adjusting the optimal product allocation mix using the optimal product allocation GUI (1004) to meet the client's needs and circumstances. The optimal product allocation GUI (1004) includes an investment GUI (1008), a variable annuity GUI (1014), and an immediate annuity GUI (1020). The investment GUI (1008) includes an investment widget (1012). In some implementations, the investment GUI (1008) includes a data field box (1010) where the user may manually enter a value that correlates to the percent of the assets allocated to investments. In some implementations, when the user adjusts the investment widget (1012), the value in data field box (1010) changes to reflect the adjustment made to the investment widget (1012). Similarly, when the user adjusts the value in data field box (1010), the investment widget (1012) changes to reflect the adjustment made to the value in data field box (1010). In some implementations, the investment GUI (1008) provides a breakdown of the investment allocation based on cash, fixed income, and equity holdings. These allocations can be adjusted manually by the user.

The variable annuity GUI (1014) includes an variable annuity widget (1018). In some implementations, the variable annuity GUI (1014) includes a data field box (1016) where the user may manually enter a value that correlates to the percent of the assets allocated to investments. In some implementations, when the user adjusts the variable annuity widget (1018), the value in data field box (1016) changes to reflect the adjustment made to the variable annuity widget (1018). Similarly, when the user adjusts the value in data field box (1016), the variable annuity widget (1018) changes to reflect the adjustment made to the value in data field box (1016). In some implementations, the variable annuity GUI (1014) provides a breakdown of the investment allocation based on fixed income and equity holdings. These allocations can be adjusted manually by the user.

The immediate annuity GUI (1020) includes an immediate annuity widget (1024). In some implementations, the immediate annuity GUI (1020) includes a data field box (1022) where the user may manually enter a value that correlates to the percent of the assets allocated to investments. In some implementations, when the user adjusts the immediate annuity widget (1024), the value in data field box (1022) changes to reflect the adjustment made to the immediate annuity widget (1024). Similarly, when the user adjusts the value in data field box (1022), the immediate annuity widget (1024) changes to reflect the adjustment made to the value in data field box (1022). In some implementations, the immediate annuity GUI (1020) provides a breakdown of the investment allocation based on fixed income. When the user adjusts the value in data field box (1022) or the immediate annuity widget (1024), the breakdown of the investment allocated to fixed income changes accordingly.

In some implementations, the total product allocation (1026) is the sum of percentage allocated to investments, variable annuities, and immediate annuities. As a user adjust the amount allocated to investments, variable annuities, and immediate annuities, allocation, the total product allocation (1026) is displayed.

In some implementations, after adjusting the allocation mix, a user may select a calculate widget (1030) to recalculate the RISS and/or PFL values and observe the effect on the client's new RISS and/or PFL. If the total product allocation (1026) does not total 100% when a user attempts to recalculate the RISS and/or PFL, the user is provided with an error message stating that the total product allocation (1026) is not 100%.

In some implementations, the RISS and/or PFL values are automatically updated in real time as the user adjust the allocation mix.

In some implementations, a user may also select a reset widget (1028) to reset the allocation to the optimal product allocation originally presented to the user.

In some implementations, the GUI (1000) also provides navigation buttons (1038). Navigation buttons (1038) may include, but are not limited to, forward, backward, and/or home buttons.

In some implementations, the GUI (1000) also provides a status bar (1032). The status bar communicates the user's progress determining the sustainability of their investment portfolio.

In some implementations, the GUI (1000) may also provide a navigation bar (1034). The navigation bar may include additional navigation buttons including buttons for client profiles, preferences, and contacts.

FIG. 11 illustrates, in accordance with some implementations, a GUI (1100) configured to receive information about an advisor and one or more clients.

When a report is going to be created, the processor will provide the user with the GUI (1100). Using the GUI (1100), a user may create and print a personalized report summarizing your client's current situation and recommended product allocation mix. Users are provided with a GUI (1100) that includes a create report information GUI (1102). The create report information GUI (1102) provides a start over widget (1114) that brings the user to client information GUI (500, FIG. 5). Users can select the start over widget (1114) if they would like to create a new product allocation scenario.

In some implementations, the GUI (1100) also includes a report information GUI (1104). The report information GUI (1104) includes a client profile name (1106) and advisor information (1108) including an advisor ID and agency number.

In some implementations, the report information GUI (1104) provides a user with the ability to enter information about an advisor and one or more clients via an advisor information GUI (1110) and a client information GUI (1112), respectively.

In some implementations, the advisor information GUI (1110) provides widgets for a user to enter information about the advisor including: first name, last name, office number, cell number, fax number, email address, firm name, and/or firm address. Additionally, the information about the advisor may be auto-populated based on information previously entered in the above described application or another application or database.

In some implementations, the client information GUI (1112) provides widgets for a user to enter information about the one or more clients including: first name and last name. Additionally, the information about the one or more clients may be auto-populated based on information previously entered in the above described application or another application or database.

In some implementations, the GUI (1100) includes a product comparisons widget (1116). Selection of the products comparison widget provides additional information about other investment and insurance products. This includes additional information regarding mutual funds, variable annuities, immediate annuities, and life insurance.

In some implementations, the GUI (1100) also provides navigation buttons (1120). Navigation buttons (1120) may include, but are not limited to, forward, backward, and/or home buttons.

In some implementations, the GUI (1100) also provides a status bar (1122). The status bar communicates the user's progress determining the sustainability of their investment portfolio.

In some implementations, the GUI (1100) may also provide a navigation bar (1118). The navigation bar may include additional navigation buttons including buttons for client profiles, preferences, and contacts.

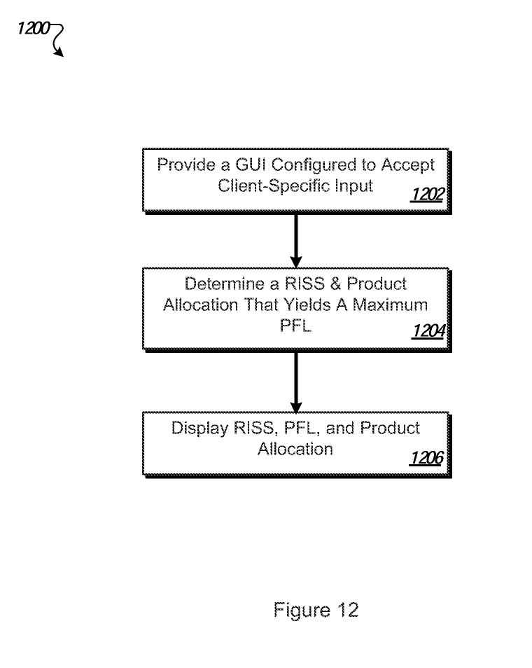

FIG. 12 illustrates, in accordance with some implementations, a method (1200), performed by a processor of a computing device, for performing an analysis of sustainability of an investment portfolio to support a retirement income need for a client and displaying a result of the analysis.

In some implementations, method (1200) begins by providing a first GUI configured to accept client-specific input (1202). The client-specific input includes at least a desired retirement income, a number of years to retirement, a current income, and a current total investment portfolio.

After providing a GUI, the processor determines a first product allocation associated with the client-specific input (1204). The first product allocation is a reallocation of the current total investment portfolio that yields a maximum PFL while maintaining a pre-determined or user-selected minimum RISS. It is an allocation among investments such as stocks, bonds, mutual funds, cash equivalents, and the like, variable annuities such as variable annuities with lifetime income guarantees, and immediate annuities such as single premium immediate annuities. The allocation to investments can be broken into subcategories of cash, fixed income, and equity. The allocation to variable annuities can be broken into cash, fixed income, and equity.

After determining the first product allocation the processor displays the RISS, the PFL, and/or the first product allocation (1206).

In some implementations, the processor may provide one or more GUI widgets that allow adjustment of the first product allocation to a second product allocation. The widgets allow independent adjustment of an allocation in each of the plurality of asset categories. In such circumstances, the processor determines an updated potential financial legacy corresponding to the second product allocation. After determining an updated potential financial legacy, the processor displays the updated potential financial legacy.

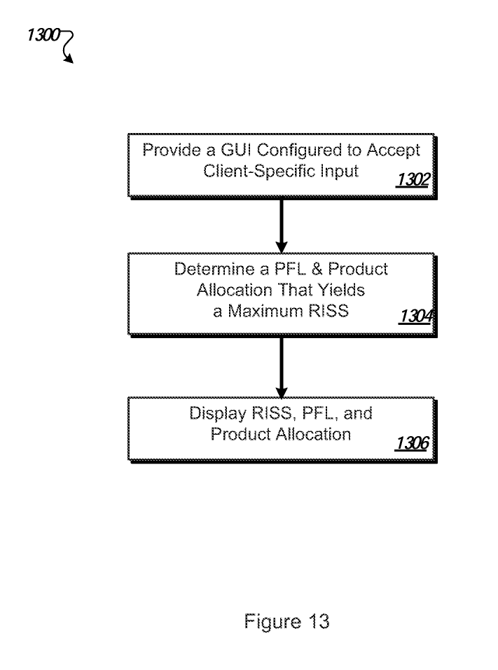

FIG. 13 illustrates, in accordance with some implementations, a method (1300), performed by a processor of a computing device, for performing an analysis of sustainability of an investment portfolio to support a retirement income need for a client and displaying a result of the analysis.

In some implementations, method (1300) begins by providing a first GUI configured to accept client-specific input (1302). The client-specific input includes at least a desired retirement income, a number of years to retirement, a current income, and a current total investment portfolio.

After providing a GUI, the processor determines a first product allocation associated with the client-specific input (1304). The first product allocation is a reallocation of the current total investment portfolio that yields a maximum RISS while maintaining a pre-determined or user-selected minimum PFL. It is an allocation among investments such as stocks, bonds, mutual funds, cash equivalents, and the like, variable annuities such as variable annuities with lifetime income guarantees, and immediate annuities such as single premium immediate annuities. The allocation to investments can be broken into subcategories of cash, fixed income, and equity. The allocation to variable annuities can be broken into cash, fixed income, and equity.

After determining the first product allocation the processor displays the RISS, the PFL, and/or the first product allocation (1306).

In some implementations, the processor may provide one or more GUI widgets that allow adjustment of the first product allocation to a second product allocation. The widgets allow independent adjustment of an allocation in each of the plurality of asset categories. In such circumstances, the processor determines an updated potential financial legacy corresponding to the second product allocation. After determining an updated potential financial legacy, the processor displays the updated potential financial legacy.

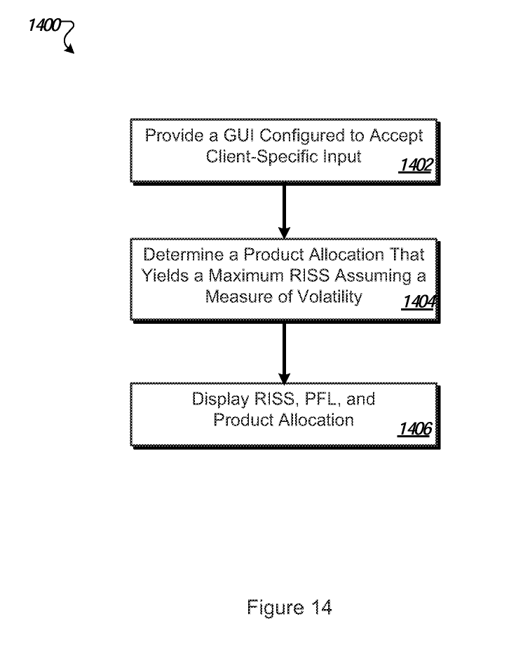

FIG. 14 illustrates, in accordance with some implementations, a method (1400), performed by a processor of a computing device, for performing an analysis of sustainability of an investment portfolio to support a retirement income need for a client and displaying a result of the analysis.

In some implementations, method (1400) begins by providing a first GUI configured to accept client-specific input (1402). The client-specific input includes at least a desired retirement income, a number of years to retirement, a current income, and a current total investment portfolio.

After providing a GUI, the processor determines a first product allocation associated with the client-specific input (1404). The first product allocation is a reallocation of the current total investment portfolio that yields a maximum RISS. It is an allocation among investments such as stocks, bonds, mutual funds, cash equivalents, and the like, variable annuities such as variable annuities with lifetime income guarantees, and immediate annuities such as single premium immediate annuities. The allocation to investments can be broken into subcategories of cash, fixed income, and equity. The allocation to variable annuities can be broken into cash, fixed income, and equity.

In some implementations, the first product allocation is determined by assigning a measure of volatility (e.g. standard deviation) as a function of a pre-determined or client-selected assumed market growth rate. For example, the assigned measure of volatility is greater for a higher assumed market growth rate.

In some implementations, the first product allocation is determined as a function of a fixed income and/or bond net rate of return, a bond volatility, a stock net rate of return, a stock volatility, and, optionally, a stock bond correlation coefficient.

After determining the first product allocation the processor displays the RISS, the PFL, and/or the first product allocation (1406).

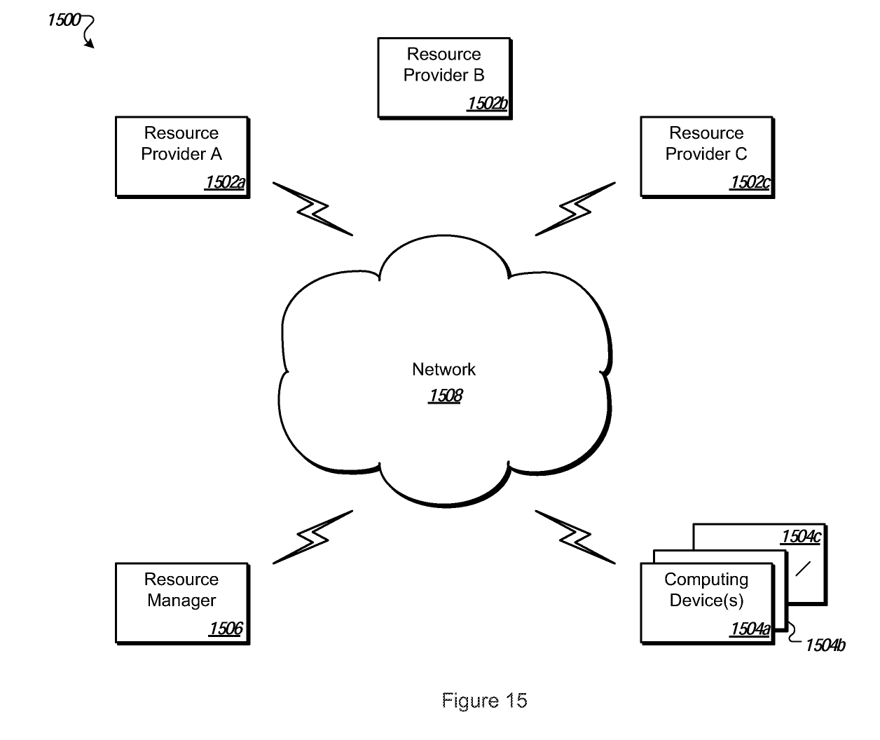

As shown in FIG. 15, an implementation of a network environment 1500 for use in determining the sustainability of a portfolio to support retirement income needs is shown and described. In brief overview, referring now to FIG. 15, a block diagram of an exemplary cloud computing environment 1500 is shown and described. The cloud computing environment 1500 may include one or more resource providers 1502a, 1502b, 1502c (collectively, 1502). Each resource provider 1502 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1502 may be connected to any other resource provider 1502 in the cloud computing environment 1500. In some implementations, the resource providers 1502 may be connected over a computer network 1508. Each resource provider 1502 may be connected to one or more computing device 1504a, 1504b, 1504c (collectively, 1504), over the computer network 1508.

The cloud computing environment 1500 may include a resource manager 1506. The resource manager 1506 may be connected to the resource providers 1502 and the computing devices 1504 over the computer network 1508. In some implementations, the resource manager 1506 may facilitate the provision of computing resources by one or more resource providers 1502 to one or more computing devices 1504. The resource manager 1506 may receive a request for a computing resource from a particular computing device 1504. The resource manager 1506 may identify one or more resource providers 1502 capable of providing the computing resource requested by the computing device 1504. The resource manager 1506 may select a resource provider 1502 to provide the computing resource. The resource manager 1506 may facilitate a connection between the resource provider 1502 and a particular computing device 1504. In some implementations, the resource manager 1506 may establish a connection between a particular resource provider 1502 and a particular computing device 1504. In some implementations, the resource manager 1506 may redirect a particular computing device 1504 to a particular resource provider 1502 with the requested computing resource.

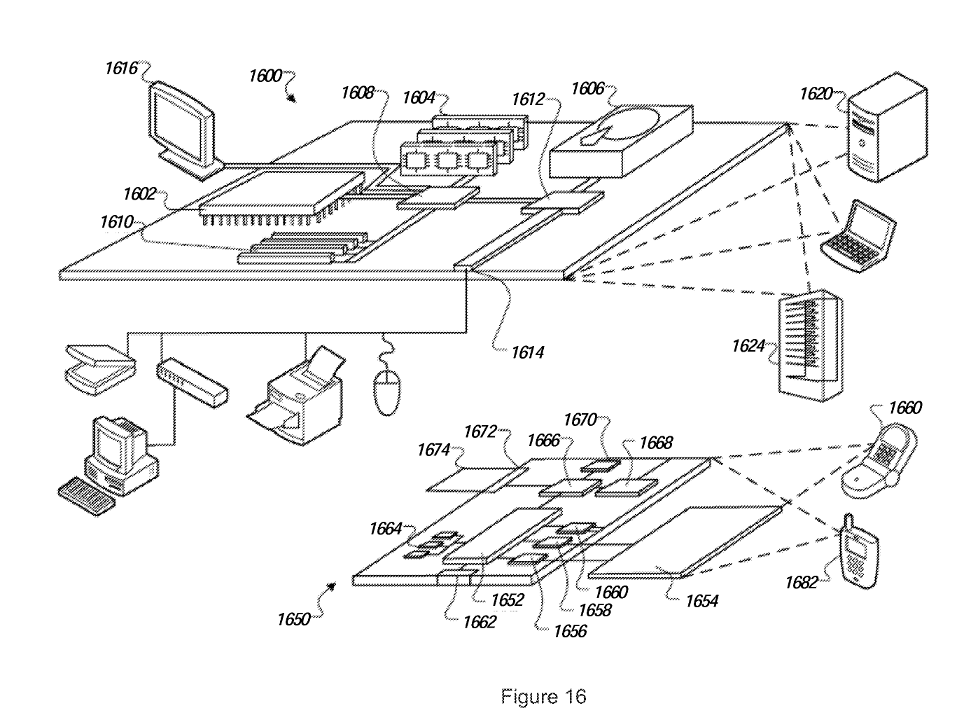

FIG. 16 shows an example of a computing device 1600 and a mobile computing device 1650 that can be used to implement the techniques described in this disclosure. The computing device 1600 is intended to represent various forms of digital computers, such as laptops, desktops, workstations, personal digital assistants, servers, blade servers, mainframes, and other appropriate computers. The mobile computing device 1650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1600 includes a processor 1602, a memory 1604, a storage device 1606, a high-speed interface 1608 connecting to the memory 1604 and multiple high-speed expansion ports 1610, and a low-speed interface 1612 connecting to a low-speed expansion port 1614 and the storage device 1606. Each of the processor 1602, the memory 1604, the storage device 1606, the high-speed interface 1608, the high-speed expansion ports 1610, and the low-speed interface 1612, are interconnected using various busses, and may be mounted on a common motherboard or in other manners as appropriate. The processor 1602 can process instructions for execution within the computing device 1600, including instructions stored in the memory 1604 or on the storage device 1606 to display graphical information for a GUI on an external input/output device, such as a display 1616 coupled to the high-speed interface 1608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1604 stores information within the computing device 1600. In some implementations, the memory 1604 is a volatile memory unit or units. In some implementations, the memory 1604 is a non-volatile memory unit or units. The memory 1604 may also be another form of computer-readable medium, such as a magnetic or optical disk.

The storage device 1606 is capable of providing mass storage for the computing device 1600. In some implementations, the storage device 1606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1602), perform one or more methods, such as those described above. The instructions can also be stored by one or more storage devices such as computer- or machine-readable mediums (for example, the memory 1604, the storage device 1606, or memory on the processor 1602).

The high-speed interface 1608 manages bandwidth-intensive operations for the computing device 1600, while the low-speed interface 1612 manages lower bandwidth-intensive operations. Such allocation of functions is an example only. In some implementations, the high-speed interface 1608 is coupled to the memory 1604, the display 1616 (e.g., through a graphics processor or accelerator), and to the high-speed expansion ports 1610, which may accept various expansion cards (not shown). In the implementation, the low-speed interface 1612 is coupled to the storage device 1606 and the low-speed expansion port 1614. The low-speed expansion port 1614, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1600 may be implemented in a number of different forms, as shown in the figure. For example, it may be implemented as a standard server 1620, or multiple times in a group of such servers. In addition, it may be implemented in a personal computer such as a laptop computer 1622. It may also be implemented as part of a rack server system 1624. Alternatively, components from the computing device 1600 may be combined with other components in a mobile device (not shown), such as a mobile computing device 1650. Each of such devices may contain one or more of the computing device 1600 and the mobile computing device 1650, and an entire system may be made up of multiple computing devices communicating with each other.

The mobile computing device 1650 includes a processor 1652, a memory 1664, an input/output device such as a display 1654, a communication interface 1666, and a transceiver 1668, among other components. The mobile computing device 1650 may also be provided with a storage device, such as a micro-drive or other device, to provide additional storage. Each of the processor 1652, the memory 1664, the display 1654, the communication interface 1666, and the transceiver 1668, are interconnected using various buses, and several of the components may be mounted on a common motherboard or in other manners as appropriate.

The processor 1652 can execute instructions within the mobile computing device 1650, including instructions stored in the memory 1664. The processor 1652 may be implemented as a chipset of chips that include separate and multiple analog and digital processors. The processor 1652 may provide, for example, for coordination of the other components of the mobile computing device 1650, such as control of user interfaces, applications run by the mobile computing device 1650, and wireless communication by the mobile computing device 1650.

The processor 1652 may communicate with a user through a control interface 1658 and a display interface 1656 coupled to the display 1654. The display 1654 may be, for example, a TFT (Thin-Film-Transistor Liquid Crystal Display) display or an OLED (Organic Light Emitting Diode) display, or other appropriate display technology. The display interface 1656 may comprise appropriate circuitry for driving the display 1654 to present graphical and other information to a user. The control interface 1658 may receive commands from a user and convert them for submission to the processor 1652. In addition, an external interface 1662 may provide communication with the processor 1652, so as to enable near area communication of the mobile computing device 1650 with other devices. The external interface 1662 may provide, for example, for wired communication in some implementations, or for wireless communication in other implementations, and multiple interfaces may also be used.

The memory 1664 stores information within the mobile computing device 1650. The memory 1664 can be implemented as one or more of a computer-readable medium or media, a volatile memory unit or units, or a non-volatile memory unit or units. An expansion memory 1674 may also be provided and connected to the mobile computing device 1650 through an expansion interface 1672, which may include, for example, a SIMM (Single In Line Memory Module) card interface. The expansion memory 1674 may provide extra storage space for the mobile computing device 1650, or may also store applications or other information for the mobile computing device 1650. Specifically, the expansion memory 1674 may include instructions to carry out or supplement the processes described above, and may include secure information also. Thus, for example, the expansion memory 1674 may be provide as a security module for the mobile computing device 1650, and may be programmed with instructions that permit secure use of the mobile computing device 1650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 1652), perform one or more methods, such as those described above. The instructions can also be stored by one or more storage devices, such as one or more computer- or machine-readable mediums (for example, the memory 1664, the expansion memory 1674, or memory on the processor 1652). In some implementations, the instructions can be received in a propagated signal, for example, over the transceiver 1668 or the external interface 1662.

The mobile computing device 1650 may communicate wirelessly through the communication interface 1666, which may include digital signal processing circuitry where necessary. The communication interface 1666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1668 using a radio-frequency. In addition, short-range communication may occur, such as using a Bluetooth®, Wi-Fi™, or other such transceiver (not shown). In addition, a GPS (Global Positioning System) receiver module 1670 may provide additional navigation- and location-related wireless data to the mobile computing device 1650, which may be used as appropriate by applications running on the mobile computing device 1650.

The mobile computing device 1650 may also communicate audibly using an audio codec 1660, which may receive spoken information from a user and convert it to usable digital information. The audio codec 1660 may likewise generate audible sound for a user, such as through a speaker, e.g., in a handset of the mobile computing device 1650. Such sound may include sound from voice telephone calls, may include recorded sound (e.g., voice messages, music files, etc.) and may also include sound generated by applications operating on the mobile computing device 1650.

The mobile computing device 1650 may be implemented in a number of different forms, as shown in the figure. For example, it may be implemented as a cellular telephone 1680. It may also be implemented as part of a smart-phone 1682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a GUI or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for performing an analysis of sustainability of an investment portfolio to support a retirement income need for a client are provided. Having described certain implementations of methods and apparatus for supporting an analysis of sustainability of an investment portfolio to support a retirement income need for a client, it will now become apparent to one of skill in the art that other implementations incorporating the concepts of the disclosure may be used. Therefore, the disclosure should not be limited to certain implementations, but rather should be limited only by the spirit and scope of the following claims.

1. A computer-implemented method for performing an analysis of sustainability of an investment portfolio to support a retirement income need for a client and displaying a result of the analysis, the method comprising the steps of:
(a) providing, by a processor of a computing device, a graphical user interface configured to accept client-specific input;
(b) determining, by the processor, a retirement income sustainability score corresponding to the client-specific input, wherein the retirement income sustainability score is a measure of sustainability of the investment portfolio to support the retirement income need for the client;
(c) displaying, by the processor, the retirement income sustainability score corresponding to the client-specific input via the graphical user interface;
(d) determining, by the processor, a first product allocation associated with the client-specific input;
(e) displaying, by the processor, the first product allocation determined in step (d);
(f) providing, by the processor, one or more graphical user interface widgets that allow adjustment of the first product allocation to a second product allocation;
(g) determining, by the processor, an updated retirement income sustainability score corresponding to the second product allocation following step (f); and
(h) displaying the updated retirement income sustainability score determined in step (g).

2. The method of claim 1, wherein the client-specific input comprises one or more members selected from the group consisting of client age, desired number of years to retirement, current income, amount of desired retirement income, estimated amount of one or more sources of guaranteed income, ‘start at’ age for each of the one or more sources of guaranteed income, amount of current total investment portfolio, and amount of planned expenses and/or deposits.

3. The method of claim 1, wherein the client-specific input comprises at least a desired retirement income, a number of years to retirement, a current income, and a current total investment portfolio.

4. The method of claim 1, wherein the client is an individual.

5. The method of claim 1, wherein the client is a couple.

6. The method of claim 5, wherein step (b) comprises determining a joint retirement income sustainability score for the couple, and wherein step (f) comprises providing, by the processor, the one or more graphical user interface widgets that allow adjustment of the first product allocation to the second product allocation for the couple, jointly.

7. The method of claim 5, wherein step (b) comprises determining a retirement income sustainability score for each individual in the couple, and wherein step (f) comprises providing, by the processor, the one or more graphical user interface widgets that allow adjustment of the first product allocation to the second product allocation for each individual in the couple.

8. The method of claim 1, further comprising determining, by the processor, a potential financial legacy according to the client-specific input and displaying the potential financial legacy via the graphical user interface, along with the retirement income sustainability score, wherein the potential financial legacy is a probability-based value indicative of the size of a possible legacy.

9. The method of claim 1, wherein step (c) comprises displaying the retirement income sustainability score corresponding to the client-specific input in step (a) along with a graphical indication of asset allocation breakdown.

10. The method of claim 9, wherein the graphical indication of asset allocation breakdown comprises a chart indicating proportion of assets in cash, in fixed income, and in equity.

11. The method of claim 1, wherein the first product allocation determined in step (d) is a reallocation of a current total investment portfolio corresponding to the client-specific input, said reallocation selected to maximize retirement income sustainability score, and wherein step (e) comprises displaying the first product allocation and the maximized retirement income sustainability score corresponding to the first product allocation.

12. The method of claim 11, wherein the first product allocation is determined and displayed as an allocation among a plurality of asset categories.

13. The method of claim 12, wherein the first product allocation is determined and displayed as an allocation among at least two of the following three categories: investments, variable annuities, and immediate annuities.

14. The method of claim 13, wherein the allocation in the category of investments is further determined and displayed as a sub-allocation in the subcategories of cash, fixed income, and equity.

15. The method of claim 13, wherein the allocation in the category of variable annuities is further determined and displayed as a sub-allocation in the subcategories of fixed income and equity.

16. The method of claim 12, wherein the one or more graphical user interface widgets in step (f) allow independent adjustment of an allocation in each of the plurality of asset categories, thereby allowing adjustment by the user from the first product allocation to the second product allocation.

17. The method of claim 12, wherein the one or more graphical user interface widgets in step (f) comprises a plurality of sliders, the position of each slider corresponding to an amount of one of the plurality of asset categories.

18. The method of claim 12, wherein the one or more graphical user interface widgets in step (f) comprises one or more of any number of the following: a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and/or a scroll bar.

19. The method of claim 12, further comprising the step of providing, by the processor, a further plurality of graphical user interface widgets that allow adjustment of a sub-allocation among a plurality of subcategories for one or more of the plurality of asset categories from a first sub-allocation to a second sub-allocation, wherein the updated retirement income sustainability score corresponds to the second allocation and the second sub-allocation.

20. The method of claim 19, wherein the further plurality of graphical user interface widgets that allow adjustment of the sub-allocation comprises one or more of any number of the following: a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and/or a scroll bar.

21. A computer-implemented method for performing an analysis of sustainability of an investment portfolio to support a retirement income need for a client and displaying a result of the analysis, the method comprising the steps of:
(a) providing, by a processor of a computing device, a first graphical user interface configured to accept client-specific input;
(b) determining, by the processor, a retirement income sustainability score corresponding to the client-specific input, wherein the retirement income sustainability score is a measure of sustainability of the investment portfolio to support the retirement income need for the client;
(c) displaying, by the processor, the retirement income sustainability score corresponding to the client-specific input via the graphical user interface;
(d) determining, by the processor, a first product allocation associated with the client-specific input;
(e) displaying, by the processor, the first product allocation determined in step (d);
(f) following step (e), displaying, by the processor, the first or a subsequent graphical user interface configured to accept client-specific input comprising: a desired face amount of life insurance and/or an amount of a life insurance premium;
(g) determining, by the processor, a potential financial legacy without life insurance and a potential financial legacy with life insurance according to the client-specific input accepted in step (f), wherein the potential financial legacy is a probability-based value indicative of the size of a possible legacy;
(h) determining, by the processor, a retirement income sustainability score without life insurance and a retirement income sustainability score with life insurance according to the client-specific input accepted in step (f); and
(i) displaying the potential financial legacy with life insurance, the potential financial legacy without life insurance, the retirement income sustainability score with life insurance, and the retirement income sustainability score without life insurance.

22. The method of claim 21, wherein the client-specific input in step (f) further comprises an indication of type of life insurance (e.g., whole, single life, or survivorship) and/or an indication of whether the client is a smoker.

23. The method of claim 21, further comprising the step of determining and displaying, by the processor, a life insurance premium corresponding to a desired face amount of life insurance where the client-specific input comprises the desired face amount of life insurance.

24. The method of claim 21, further comprising the step of determining and displaying, by the processor, a face amount of life insurance corresponding to a life insurance premium where the client-specific input comprises the life insurance premium.

25. The method of claim 21, wherein the first product allocation determined in step (d) is a reallocation of a current total investment portfolio corresponding to the client-specific input, said reallocation selected to maximize retirement income sustainability score, wherein the method further comprises the step of determining, by the processor, whether the maximized retirement income sustainability score meets a predetermined criterion, and proceeding to step (f) only if the criterion is met.

26. The method of claim 21, wherein the client-specific input in step (f) further comprises a selection by the client of a cash-value life insurance policy, and wherein the method comprises determining, by the processor, both the potential financial legacy with life insurance and the retirement income sustainability score with life insurance taking into account the cash value of the cash-value life insurance policy.

27. The method of claim 21, wherein the client-specific input in step (a) comprises at least a desired retirement income, a number of years to retirement, a current income, and a current total investment portfolio.

28-56. (canceled)

57. A non-transitory computer-readable medium, wherein the computer-readable medium stores instructions that, when executed by a processor, cause the processor to:
(a) provide a graphical user interface configured to accept client-specific input;
(b) determine a retirement income sustainability score corresponding to the client-specific input, wherein the retirement income sustainability score is a measure of sustainability of the investment portfolio to support the retirement income need for the client;
(c) display the retirement income sustainability score corresponding to the client-specific input via the graphical user interface;
(d) determine a first product allocation associated with the client-specific input;
(e) display the first product allocation determined in step (d);
(f) provide one or more graphical user interface widgets that allow adjustment of the first product allocation to a second product allocation;
(g) determine an updated retirement income sustainability score corresponding to the second product allocation following step (f); and
(h) display the updated retirement income sustainability score determined in step (g).
